(19) United States
(12) Patent Application Publication
(10) Pub. No.: US 2025/0282386 A1
(43) Pub. Date: Sep. 11, 2025

(54) ELECTRONIC DEVICE AND METHOD FOR DETECTING EXTERNAL OBJECT

(71) Applicant: THINKWARE CORPORATION, Seongnam-si (KR)

(72) Inventor: Yosep Park, Seongnam-si (KR)

(21) Appl. No.: 19/074,259

(22) Filed: Mar. 7, 2025

(30) Foreign Application Priority Data
Mar. 8, 2024 (KR) 10-2024-0033514

(51) Int. Cl. B60W 60/00; G06V 10/764; G06V 10/82; G06V 20/58

(52) U.S. Cl. CPC B60W 60/0015; G06V 10/764; G06V 10/82; G06V 20/58; B60W 2420/403; B60W 2520/10; B60W 2554/80; B60W 2556/40; B60W 2556/45

(57) ABSTRACT

An electronic device may, based on detecting an external object included in an image, obtain first information related to the external object using a first model, based on the first information, estimate a first road region related to a road in the image, based on map data, estimate a second road region in the image, compare the first road region and the second road region to extract a partial region related to an undetected external object by the first model, and obtain second information related to the undetected external object in the partial region from the second model.

### CROSS-REFERENCE TO RELATED APPLICATIONS

This application is based on and claims priority under 35 U.S.C. § 119 to Korean Patent Application No. 10-2024-0033514, filed on Mar. 8, 2024, in the Korean Intellectual Property Office, the disclosure of which is incorporated by reference herein its entirety.

### BACKGROUND

### Field

The disclosure relates to an electronic device and method for identifying an external object.

### Description of Related Art

Autonomous driving is a technology that allows a vehicle to determine a driving route on its own without driver intervention and control the vehicle to drive along the determined route. An electronic device for autonomous driving of a vehicle may detect external objects positioned outside the vehicle. The electronic device may classify a class of an external object and identify the location and size of the external object by an object detection model.

### SUMMARY

In electronic devices for autonomous vehicles, methods are being studied to reduce the burden of detecting external objects that are not classified by image detection models.

An electronic device for autonomous driving of a vehicle is provided. The electronic device may comprise a processor, a memory storing instructions, and a camera. The instructions may, when executed by the processor, cause the electronic device to obtain an image related to a front side of the vehicle via the camera, based on detecting an external object included in the image, obtain first information related to the external object using a first model, based on the first information, estimate a first road region related to a road in the image, based on map data, estimate a second road region in the image, compare the first road region and the second road region to extract a partial region related to an undetected external object by the first model, and input the partial region to a second model to obtain second information related to the undetected external object in the partial region from the second model.

A method of an electronic for autonomous driving of a vehicle is provided. The method may comprise obtaining an image related to a front side of the vehicle, based on detecting an external object included in the image, obtaining first information related to the external object using a first model, based on the first information, estimating a first road region related to a road in the image, based on map data, estimating a second road region in the image, comparing the first road region and the second road region to extract a partial region related to an undetected external object by the first model, and inputting the partial region to a second model to obtain second information related to the undetected external object in the partial region from the second model.

It is possible to secure the stability of autonomous vehicles by detecting external objects that are not detected by the object detection model.

### BRIEF DESCRIPTION OF THE DRAWINGS

FIG. 1 schematically illustrates an autonomous vehicle.

FIG. 2 is a block diagram illustrating an electronic device according to an embodiment.

FIG. 3A is a view illustrating a first model.

FIG. 3B is a view illustrating a second model.

FIG. 4 illustrates an operation of detecting an external object by an electronic device according to an embodiment.

FIG. 5A illustrates a process of estimating a first road region from an image captured through a camera using a first model.

FIG. 5B illustrates a process of estimating a second road region from an image captured through a camera using map data.

FIG. 6A illustrates a process of detecting an external object using a first model.

FIG. 6B illustrates a process of detecting an external object using a second model.

FIG. 7 is a flowchart illustrating an operation of controlling a vehicle by an electronic device according to an embodiment.

FIG. 8 is a flowchart illustrating an operation of controlling a vehicle before detecting an undetected external object by an electronic device according to an embodiment.

FIG. 9 is a flowchart illustrating an operation of transmitting second information to an external electronic device by an electronic device according to an embodiment.

FIG. 10 is a block diagram illustrating an example of an autonomous driving system of a vehicle according to an embodiment.

FIG. 11 is a block diagrams illustrating an example of an autonomous driving moving object according to an embodiment.

FIG. 12 is a block diagrams illustrating an example of an autonomous driving moving object according to an embodiment.

FIG. 13 illustrates an example of a gateway related to a user device according to various embodiments.

FIG. 14 is a view illustrating operations of an electronic device training a neural network based on a set of training data according to an embodiment.

FIG. 15 is a block diagram illustrating an electronic device according to an embodiment.

FIG. 16A illustrates an example of an autonomous vehicle.

FIG. 16B illustrates an example of an autonomous vehicle.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 100). For example, a processor (e.g., the processor 110) of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Hereinafter, embodiments of the disclosure are described with reference to the accompanying drawings.

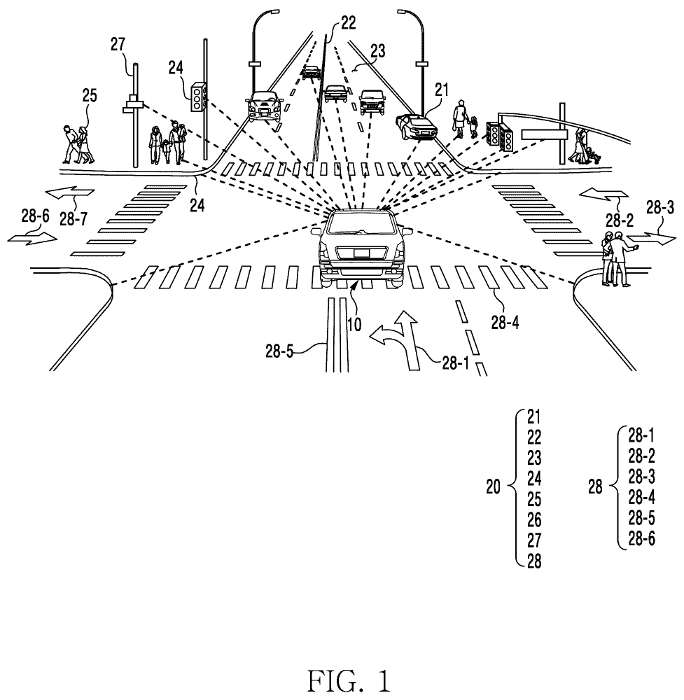

FIG. 1 schematically illustrates an autonomous vehicle.

Autonomous driving is a technology in which the vehicle 10 controls driving by itself without a driver's manipulation. The autonomous vehicle 10 may identify an external object 20 from an image (or video) of the ambient environment obtained through the camera 140 and plan a driving route based on the identified external object 20. The autonomous vehicle 10 may control the driving of the vehicle 10 based on the planned driving route.

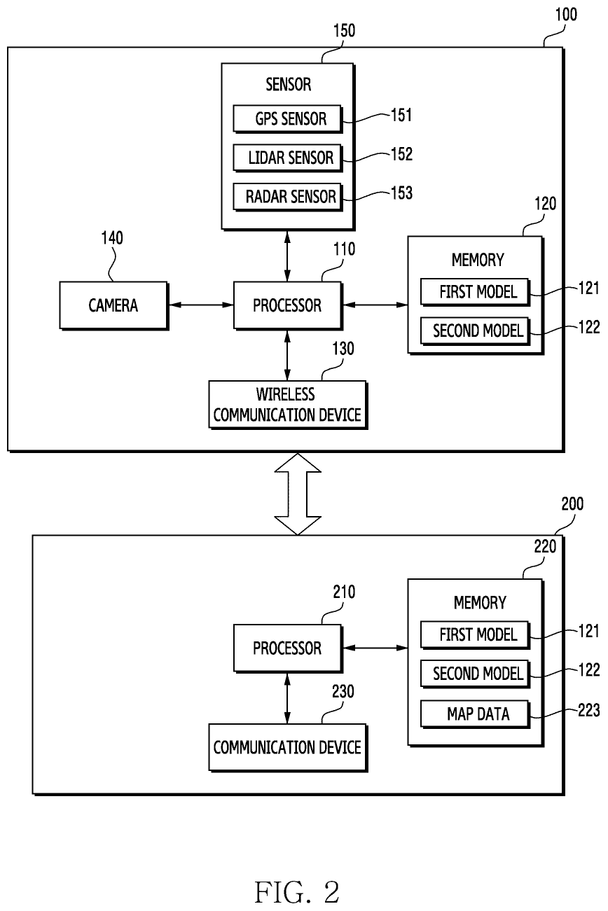

According to an embodiment, the electronic device 100 for autonomous driving disposed in the autonomous vehicle 10 may be configured to control the driving of the vehicle 10 based on the external object 20. For example, the electronic device 100 may include a camera (e.g., camera 140 of FIG. 2) for obtaining a front image (or a front video) of a front side of the vehicle 10 and/or a sensor (e.g., the LiDAR sensor 152 and/or the RADAR sensor 153 of FIG. 2) for sensing the external object 20. The electronic device 100 may identify the external object 20 included in the image and control the driving of the vehicle 10 based on the identified external object 20.

For example, the external object 20 may include, but is not limited to, another vehicle 21, a lane 22, a road 23, a traffic light 24, a pedestrian 25, a curb 26, a road sign 27, and/or a road mark 28. For example, based on identifying the traffic light 24, the driving of the vehicle 10 may be controlled according to the signal indicated by the traffic light 24 (e.g., a driving signal or a stop signal). For example, based on identifying the pedestrian 25, the vehicle 10 may be controlled to stop or to avoid the pedestrian 25. The electronic device 100 may identify the external object 20 included in the image using the neural network model stored in the memory 120. The electronic device 100 may identify the road mark 28 for displaying regulations and/or instructions regarding lane and road traffic on the road surface. For example, the electronic device 100 may control the driving of the vehicle 10 according to the information indicated by the road mark 28 based on identifying the road mark 28. For example, the electronic device 100 may control the driving direction when the vehicle 10 passes through an intersection based on identifying the straight and left-turnable road mark 28-1 displayed on the driving lane of the vehicle 10. For example, the electronic device 101 may control the driving of the vehicle 10 according to the instruction of each road mark, based on identifying the road mark, such as road marks 28-2 and 28-7 for going straight in a first direction, road marks 28-3 and 28-6 for going straight in a second direction opposite to the first direction, crosswalk 28-4, and/or center line 28-5 displayed on the driving lane.

In order for the electronic device 100 to safely control the vehicle 10, accurate detection of the external object 20 may be required. Detection of the external object 20 may be performed through classification of the external object 20 and/or detection of the size and position of the external object 20. For safe driving, accurate and rapid detection of the external object 20 is required. For example, the electronic device 100 may include an object detection (OD) model for detecting the external object 20. The object detection model may provide classification of the external object 20 and identification of the position and size of the external object 20, but the detection of the external object 20 may be limited due to the limitation of classifiable classes. For example, when the external object 20 that is difficult to classify by the object detection model is present on the road 23, an accident may occur if the object detection model does not identify the external object 20. For example, when an object that is difficult to find on the road 23 (e.g., a container, fragments of an accident vehicle, a machine, and/or an animal) is present in front of the vehicle 10, the electronic device 100 may have difficulty in detecting the object. When the object is not detected, an accident may occur.

The electronic device 100 according to an embodiment may use an object detection model (e.g., the first model 121 of FIG. 2) and a class classification model (e.g., the second model 122 of FIG. 2) to accurately detect the external object 20 present on the road 23. When the external object 20 is not detected using the first model 121, the electronic device 100 according to an embodiment may detect the external object 20 present in front of the vehicle 10 using the second model 122, and control the driving of the vehicle 10 based on the detected external object 20.

An electronic device 100 according to an embodiment is described below.

FIG. 2 is a block diagram illustrating an electronic device according to an embodiment.

Referring to FIG. 2, an electronic device 100 according to an embodiment may include a processor 110, a memory 120, a wireless communication device 130, a camera 140, and/or a sensor 150. The electronic device 100 according to an embodiment may be referred to as an electronic device 100 disposed in an autonomous vehicle (e.g., the vehicle 10 of FIG. 1).

For example, the processor 110, the memory 120, the wireless communication device 130, a camera 140, and/or a sensor 150 may be electrically and/or operatively connected to each other by an electronic component such as a communication bus. Hereinafter, “pieces of hardware are operatively coupled” may mean that a direct or indirect connection between the pieces of hardware is established wiredly or wirelessly so that a second piece of hardware is controlled by a first piece of hardware among the pieces of hardware.

Although FIG. 2 illustrates that the processor 110, the memory 120, the camera 140, the wireless communication device 130, and/or the GPS sensor 151 in different blocks, the disclosure is not limited thereto. Some of the pieces of hardware of FIG. 2 may be implemented as a single integrated circuit such as a system on chip (SoC) or a single package.

The memory 120 according to an embodiment may store instructions. The processor 110 may be configured to process data based on the instructions stored in the memory 120. For example, the processor 110 may include an arithmetic and logic unit (ALU), a floating point unit (FPU), a field programmable gate array (FPGA), a central processing unit (CPU), and/or an application processor (AP). The processor 110 may have a structure of a single-core processor or a structure of a multi-core processor such as a dual core, a quad core, a hexa core, or an octa core.

According to an embodiment, the memory 120 may include a hardware component for storing data and/or instructions executable by the processor 110. The memory 120 may include, e.g., volatile memory such as random-access memory (RAM), and/or non-volatile memory such as read-only memory (ROM). For example, the volatile memory may include, e.g., at least one of dynamic RAM (DRAM), static RAM (SRAM), cache RAM, and pseudo SRAM (PSRAM). For example, the non-volatile memory may include at least one of, e.g., programmable ROM (PROM), erasable PROM (EPROM), electrically erasable PROM (EEPROM), flash memory, hard disk, compact disk, solid state drive (SSD), and embedded multi-media card (eMMC). For example, the memory 120 of the electronic device 100 may include a first model 121 and a second model 122 used to detect an external object 20. The electronic device 100 may identify an external object 20 (e.g., the external object 20 of FIG. 1) using the first model 121 and/or the second model 122 stored in the memory 120.

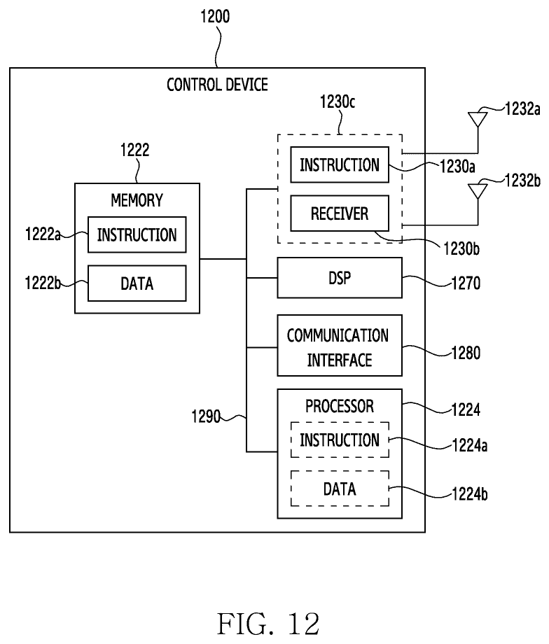

According to an embodiment, the wireless communication device 130 may be used for wireless communication with an external electronic device 200 (e.g., a server). The wireless communication device 130 may be electrically connected to an antenna (e.g., the antenna 1232a or 1232b of FIG. 12) for transmitting and/or receiving a signal. The wireless communication device 130 may convert an analog signal provided from the processor 110 into a digital signal and upconvert a baseband signal into a radio frequency (RF) signal. The electronic device 100 may obtain information related to the real-time position of the vehicle 10 using the global positioning system (GPS) sensor 151 and transmit data including the information to the external electronic device 200 using the wireless communication device 130.

According to an embodiment, the camera 140 may include a lens assembly or an image sensor. The lens assembly may collect light emitted or reflected from an object whose image is to be taken. The lens assembly may include one or more lenses. For example, the camera 140 may include a plurality of lens assemblies. For example, some of the plurality of lens assemblies of the camera 140 may have the same lens attribute (e.g., field of view, focal length, auto-focusing, f number, or optical zoom), or at least one lens assembly may have one or more lens attributes different from those of another lens assembly. The lens assembly may include a wide-angle lens or a telephoto lens. For example, the electronic device 100 may include a flash for the camera 140. The flash may include one or more light emitting diodes (LEDs) (e.g., a red-green-blue (RGB) LED, a white LED, an infrared (IR) LED, or an ultraviolet (UV) LED) or a xenon lamp. For example, the image sensor may obtain an image corresponding to an object by converting light emitted or reflected from the object and transmitted via the lens assembly into an electrical signal. According to an embodiment, the image sensor may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor may be implemented using, e.g., a charged coupled device (CCD) sensor or a complementary metal oxide semiconductor (CMOS) sensor.

According to an embodiment, the electronic device 100 may obtain images and/or videos of the front side of the vehicle 10 using the camera 140. For example, the electronic device 100 may identify an external object 20 based on an image obtained through the camera 140. For example, the electronic device 100 may identify the external object 20 from the image obtained through the camera 140 using the first model 121 and/or the second model 122. For example, the electronic device 100 may obtain an image corresponding to a pedestrian (e.g., the pedestrian 25 of FIG. 1) through the camera 140 and identify the pedestrian 25 from the image.

For example, the external electronic device 200 may be referred to as a server for the autonomous vehicle 10. The external electronic device 200 may provide map data 223 for autonomous driving of the vehicle 10. The map data 223 may be used to determine a driving route of vehicle 10. The external electronic device 200 may transmit the map data 223 based on a request for transmission of the map data 223 from the wireless communication device 130 of the electronic device 100 through the communication circuit 230. The processor 210 of the external electronic device 200 may include the memory 220 storing the first model 121 and the second model 122 for detecting the external objects 20 that may be positioned on the driving route. The external electronic device 200 may update the first model 121 and the second model 122 by training them, and provide the updated first model 121 and second model 122 to the electronic device 100 through the communication circuit 230.

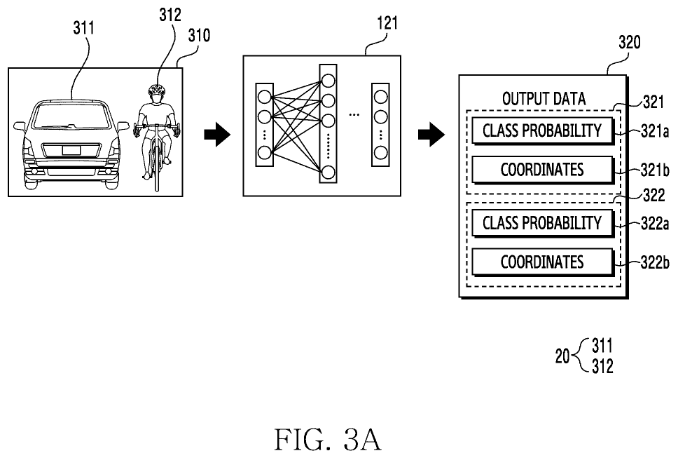

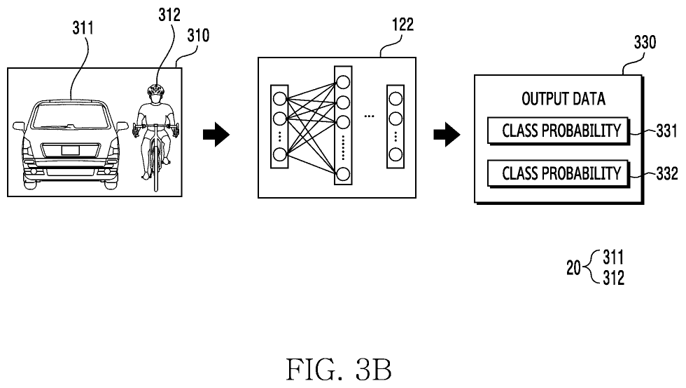

FIG. 3A is a view illustrating a first model. FIG. 3B is a view illustrating a second model.

Referring to FIG. 3A, the first model 121 may be used for class classification and position identification of the external object 20. For example, the first model 121 may include a class related to the external object 20 in the image 310 and an object detection model trained to output the position and size related to the external object 20. If the image 310 including the external object 20 is input to the first model 121, the first model 121 may provide, from the image, output data 320 including data 321a and 322a including probability values related to the class of the external object 20 and data 321b and 322b including coordinate values related to the position of the external object 20.

For example, if an image 310 including the external object 20 is input to the first model 121, the first model 121 may classify the external object 20 in the image 310. For example, the first model 121 may classify the external object 20 included in the image 310 into any one of the classes. The first model 121 may generate a bounding box surrounding the classified external object 20. The bounding box may extract the position of the external object 20 in the form of a bounding box parallel to the x-axis and y-axis. For example, the coordinate values of the bounding box may be expressed as (maximum x coordinate value, maximum y coordinate value) and (minimum x coordinate value, minimum y coordinate value). The first model 121 may extract one or more bounding boxes and provide output data 320 including data 321a and 322a including the probability value related to the class of the external object 20 positioned in the one or more bounding boxes and data 321b and 322b including coordinate values related to the position of the external object 20. For example, when the image 310 includes a first object (e.g., a car) 311 and a second object (e.g., a bicycle) 312, the first model 121 may provide output data 320 including the class, size, and position of the first object 311, and the class, size, and position of the second object 312. For example, the output data 320 may provide data 321 including the class, probability value 321a, size, and coordinate value 321b indicating the position, of a vehicle, and data 322 including the class, probability value 322a, size, and coordinate value 322b indicating the position, of a bicycle. For example, when the probability that the external object may be classified as a vehicle is a threshold probability or more, the class of the vehicle may be classified as a vehicle.

According to an embodiment, the second model 122 may be different from the first model 121. Referring to FIG. 3B, the second model 122 may be used for class classification of the external object 20. For example, the second model 122 may include a class classification model trained to output a class related to the external object 20 in the image 310. If the image 310 including the external object 20 is input to the second model 122, the second model 122 may provide, from the image 310, output data 330 including probability values 331 and 332 related to the class of the external object 20.

For example, if the image 310 including the external object 20 is input to the second model 122, the second model 122 may classify the external object 20 in the image 310. The second model 122 may extract a feature used to identify the external object 20 in the image 310. The second model 122 may provide output data 330 including probability values 331 and 332 related to the class of the external object 20 from the extracted feature. For example, when the image 310 includes a first object (e.g., a car) 311 and a second object (e.g., a bicycle) 312, the second model 122 may provide output data 330 including data 331 including the probability value of the class of the first object 311 and data 332 including the probability value of the class of the second object 312. For example, the output data 330 may be used to classify the class of the external object 20.

In general, an electronic device (e.g., the electronic device 100 the FIG. 1) for an autonomous vehicle (e.g., the vehicle 10 of FIG. 1) may use the first model 121. In order to determine the driving route of the vehicle 10, not only class classification of the external object 20 but also the position and size of the external object 20 need to be detected, so that the electronic device 100 may detect the external object 20 using the first model 121. The second model 122 may be used when it is necessary to recognize only class classification of the external object 20. The second model 122 may be used when the position and size of the external object 20 included in the image are not important. For example, the second model 122 may be used for medical image analysis. For example, when an image obtained through the camera (e.g., the camera 140 of FIG. 2) includes a first object (e.g., a car) 311 and a second object (e.g., a bicycle) 312, such as the image 310, the first model 121 may output output data that may provide the class of the car and the classification of the bicycle.

For example, the types of classes that the first model 121 may classify may be fewer than the types of classes that the second model 122 may classify. For example, there may be about 100 types of classes that the first model 121 may classify, and there may be about 1,000 or more types of classes that the second model 122 may classify. The second model 122 may classify the class of the external object 20 that is not classified by the first model 121.

The electronic device 100 according to an embodiment may use the first model 121 and/or the second model 122 to determine a driving route of the vehicle 10 and control the driving of the vehicle 10. Hereinafter, the operation of the electronic device 100 is described.

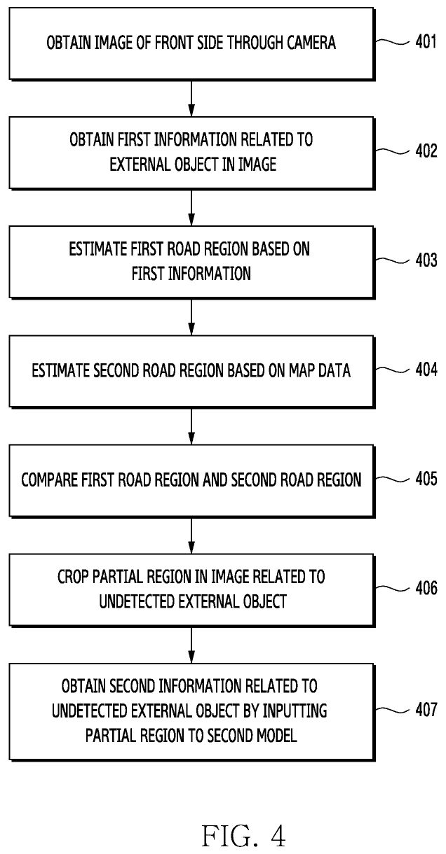

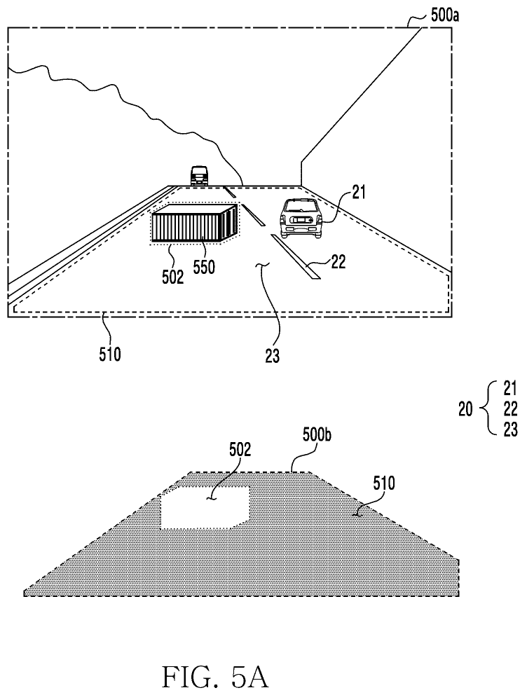

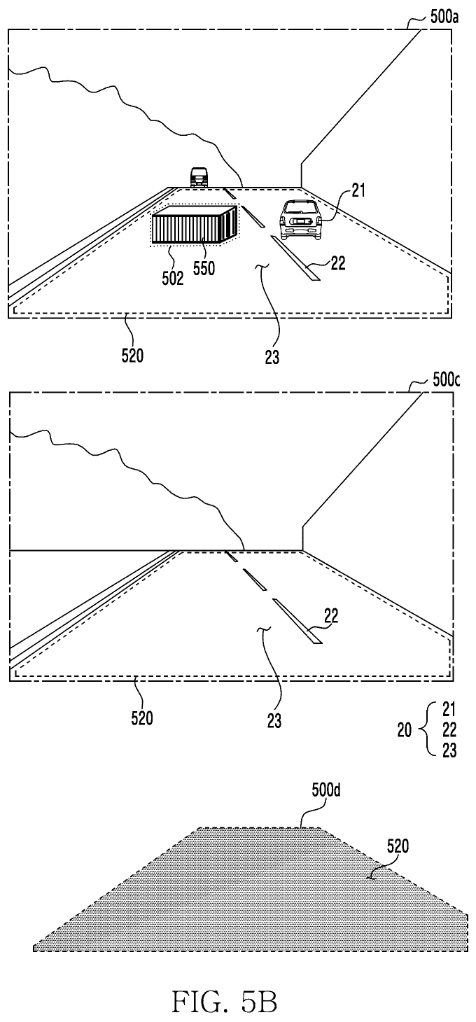

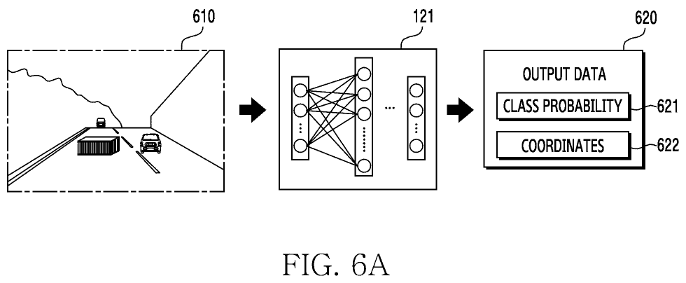

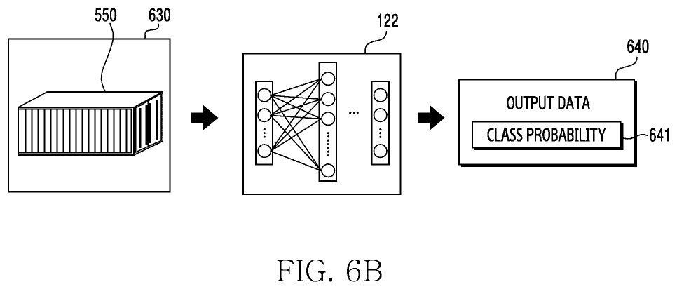

FIG. 4 illustrates an operation of detecting an external object by an electronic device according to an embodiment. FIG. 5A illustrates a process of estimating a first road region from an image captured through a camera using a first model. FIG. 5B illustrates a process of estimating a second road region from an image captured through a camera using map data. FIG. 6A illustrates a process of detecting an external object using a first model. FIG. 6B illustrates a process of detecting an external object using a second model.

The operations shown in FIG. 4 may be operations of an electronic device (e.g., the electronic device 100 of FIG. 2) that are caused when instructions stored in the memory (e.g., the memory 120 of FIG. 2) are executed by the processor (e.g., the processor 110 of FIG. 1).

Referring to FIG. 4, in operation 401, the processor 110 may obtain an image of a front side through a camera (e.g., the camera 140 of FIG. 2).

For example, the instructions stored in the memory 120 may, when executed by the processor 110, cause the electronic device 100 to obtain an image and/or a video captured through the camera 140. In the disclosure, the operation of obtaining an image through the camera 140 and identifying an external object (e.g., the external object 20 of FIG. 1) in the image is described, but the disclosure is not limited thereto. For example, an image may be replaced by a video. For example, the camera 140 may be disposed toward the front so as to capture an image of the front side of the vehicle (e.g., the vehicle 10 of FIG. 1). The camera 140 facing the front may capture, in advance, a route on which the vehicle 10 is to drive. The camera 140 may provide the captured image to the processor 110.

In operation 402, the processor 110 may obtain first information related to the external object 20 in the image.

For example, the instructions stored in the memory 120 may, when executed by the processor 110, cause the electronic device 100 to obtain first information related to the external object 20 using the first model (e.g., the first model 121 of FIG. 2) based on detecting the external object 20 included in the image.

500a of FIG. 5A is an image of the front side of the vehicle 10 captured through the camera 140, and 500b of FIG. 5A represents the first road region 510 estimated from the image.

Referring to FIG. 5A, the external object 20 may be included in the image captured by the camera 140. For example, another vehicle 21, a lane 22, and a road 23 positioned around the driving vehicle 10 may be included in the image. The processor 110 may detect the external object 20 included in the image by inputting the image to the first model 121. The first model 121 may detect the class, position, and size of the external object 20.

Referring to FIG. 6A, the processor 110 may input an image 610 captured through the camera 140 to the first model 121. The first model 121 may output data 620 including the probability value 621 of the class of the external object 20 and the coordinate value 622 indicating the position and size of the external object 20 using a plurality of layers (e.g., a plurality of convolution layers). For example, the processor 110 may obtain first information including information about the class, position, and size of the external object 20 included in the image using the first model 121.

For example, when the external object 20 included in the image 610 corresponds to a class that the first model 121 may not classify, the first model 121 may not detect the external object 20. For example, when the first model 121 may not classify the container, the first model 121 may not classify the container in the image. The undetected container may be classified as an unclassified object (e.g., an undetected external object 550). However, since the first model 121 may identify the position and size of the external object 20, the position and size of the container may be detected even if the class of the container may not be classified. The first model 121 may classify the container as an undetected external object 550 and output data 620 including the coordinate value 622 for the position and size of the container. The first information may include information about the position and size of the container. According to an embodiment, the processor 110 may obtain the first information including information about the class, position, and size of the undetected external object 550 included in the image.

In operation 403, the processor 110 may estimate the first road region 510 based on the first information.

For example, the instructions stored in the memory 120 may, when executed by the processor 110, cause the electronic device 100 to estimate the first road region 510 related to the road 23 in the image based on the obtained first information.

As illustrated in FIG. 5A, the processor 110 may estimate a region including the pixels corresponding to the road 23 in the image as the first road region 510. The processor 110 may estimate the region detected as the road 23 in the image as the first road region 510 using the first model 121. In the case of the region 502 including the pixels corresponding to the undetected external object 550 for which the class has not been classified, since it may not be distinguished whether the region is the first road region 510 or a region related to the external object 20, the region 502 including the pixels corresponding to the undetected external object 550 may be excluded from the first road region 510. The estimated first road region 510 may not include the region 502.

In operation 404, the processor 110 may estimate the second road region (e.g., the second road region 520 of FIG. 5B) based on the map data (e.g., the map data 223 of FIG. 2).

For example, the instructions stored in the memory 120 may, when executed by the processor 110, cause the electronic device 100 to estimate the second road region 520 in the image based on the map data 223.

500a of FIG. 5B is an image of the front side of the vehicle 10 captured through the camera 140, 500c of FIG. 5B is an image of the front side of the vehicle 10 included in the map data 223, and 500d of FIG. 5B represents the second road region 520 estimated based on the map data 223.

Referring to FIG. 5B, the electronic device 100 may obtain map data 223. For example, the electronic device 100 may receive the map data 223 from the external electronic device 200. if data indicating the current position of the vehicle 10 is transmitted to the external electronic device 200 through the electronic device 100, the external electronic device 200 may transmit the map data 223 indicating the current position of the vehicle 10 to the electronic device 100. Providing the map data 223 may be performed in real-time. The map data 223 may include a previously captured image 500c. Since the image 500c is a previously captured image, it may not include the external object 20. For example, when the undetected external object 550 is not positioned on the road at the time when the image 500c is captured to generate the map data 223, the undetected external object 550 may not be included in the image 500c.

According to an embodiment, the processor 110 may be configured to estimate the second road region 520 in the image 500a obtained through the camera 140 based on the image 500c included in the map data 223. Since the image 500c is a previously captured image in which the real-time circumstance of the road 23 is not reflected, the processor 110 may estimate the second road region 520 based on the image 500c without considering the undetected external object 550 from the image 500a. Even when an external object (e.g., the undetected external object 550) that is difficult to classify by the first model 121 is present on the actual road 23, when the undetected external object 550 is not present in the image 500c, the estimated second road region 520 may include a region 502 including pixels corresponding to the undetected external object 550.

In operation 405, the processor 110 may compare the first road region 510 and the second road region 520.

For example, the instructions stored in the memory 120 may, when executed by the processor 110, cause the electronic device 100 to compare the first road region (e.g., the first road region 510 of FIG. 5A) and the second road region (e.g., the second road region 520 of FIG. 5B) and identify whether the first road region 510 and the second road region 520 match.

If comparing 500b of FIG. 5A with 500d of FIG. 5B, the first road region 510 and the second road region 520 may be different. Referring to FIG. 5A, since the first road region 510 estimated using the first model 121 is estimated considering the external object 20 present on the actual road 23, the region 502 including the pixels corresponding to the undetected external object 550 not classified by the first model 121 may not be estimated as the first road region 510. Referring to FIG. 5B, the second road region 520 estimated based on the map data 223 is estimated using a previously captured image, so even when the undetected external object 550 is present on the road 23, the second road region 520 may be estimated without considering the undetected external object 550. The second road region 520 may include a region 502 including the pixels corresponding to the undetected external object 550.

According to an embodiment, the processor 110 may identify the difference between the first road region 510 and the second road region 520. When the undetected external object 550 is present on the road 23, the difference may be a region 502 including the pixels corresponding to the undetected external object 550.

In operation 406, the processor 110 may crop a partial region (e.g., the region 502) in the image related to the undetected external object 550.

For example, the instructions stored in the memory 120 may, when executed by the processor 110, cause the electronic device 100 to compare the first road region 510 and the second road region 520 to extract a partial region in the image related to the external object 550 undetected by the first model 121.

According to an embodiment, the processor 110 may compare the first road region 510 with the second road region 520, identify a partial region in the image related to the external object 550 undetected by the first model 121, and extract the region, generating a cropped image (e.g., the cropped image 630 of FIG. 6B). The cropped image 630 may include the region 502 including the pixels corresponding to the undetected external object 550. The processor 110 may generate the cropped image 630 to classify the undetected external object 550.

In operation 407, the processor 110 may input the partial region to the second model 122 to obtain second information related to the undetected external object 550.

For example, the instructions stored in the memory 120 may, when executed by the processor 110, cause the electronic device 100 to input the extracted partial region to the second model 122 to obtain second information related to the undetected external object 550 in the partial region from the second model 122.

Referring to FIG. 6B, the processor 110 may input the extracted cropped image 630 to the second model 122 to classify the undetected external object 550 included in the cropped image 630. The second model 122 may classify the class of the external object 20 using a plurality of layers (e.g., a plurality of convolution layers). As described with reference to FIG. 3B, the second model 122 may not detect the position and size of the external object 20, but includes more information about class classifications than the first model 121 and thus may classify the class of the undetected external object 550. For example, when the undetected external object 550 is a container, the first model 121 may not classify the class of the container, but may detect the position and size of the container. The second model 122 may not detect the position and size of the container, but may classify the class of the container. Therefore, if the cropped image 630 is input to the second model 122, the second model 122 may classify the undetected external object 550 in the cropped image 630 as a container. The processor 110 may obtain second information indicating that the undetected external object 550 is a container using the second model 122.

The electronic device 100 according to an embodiment may use the first model 121 and/or the second model 122 to detect the external object 20 from the image of the front side of the vehicle 10 obtained through the camera 140. For example, when there is no undetected external object 20 in front, the first road region 510 estimated through the first model 121 may match the second road region 520 estimated based on the map data 223. When the first road region 510 and the second road region 520 match, the electronic device 100 may determine a driving route of the vehicle 10 based on the detected external object 20 and control the driving of the vehicle 10 based on the determined driving route. For example, when the external object 20 is detected as an external object 20 that does not require avoidance, such as a bump, the electronic device 100 may determine a driving route that avoids a bump or a driving route passing through a bump. For example, when the external object 20 is detected as an external object 20 requiring avoidance, such as another vehicle 21, the electronic device 100 may determine a driving route for avoiding the other vehicle 21 and control the driving of the vehicle 10 based on the determined driving route.

For example, when there is an undetected external object 20 in front, the first road region 510 may include a partial region that does not match the second road region 520. When there is an external object 550 undetected by the first model 121, the region 502 including the pixels corresponding to the undetected external object 550 may not be estimated as the first road region 510 by the portion occupied by the undetected external object 550. The electronic device 100 may extract the region 502 including the pixels corresponding to the undetected external object 550, generate a cropped image 630, and input the generated cropped image 630 to the second model 122 to classify the class of the undetected external object 550. Since the second model 122 includes information about more class classifications than the first model 121, the class of the undetected external object 550 may be classified by the second model 122. The electronic device 100 may determine a driving route of the vehicle 10 based on the first information and the second information including information related to the class of the undetected external object 550, and control the driving of the vehicle 10 based on the determined driving route. For example, when the undetected external object 550 is detected by the second model 122 as an external object 20 that does not require avoidance, the electronic device 100 may determine a driving route passing through the bump or a driving route avoiding the bump. For example, when the undetected external object 550 is detected by the second model 122 as an external object 20 requiring avoidance, such as another vehicle 21, the electronic device 100 may determine a driving route to avoid another vehicle 21. The electronic device 100 may control the driving of the vehicle 10 based on the determined driving route.

According to an embodiment, the second model 122 may provide top-5 accuracy that provides five classes with the highest probability so that the class of the external object 20 may be accurately classified. When the five classes include at least one to be avoided for driving of the vehicle 10, the electronic device 100 may determine a driving route avoiding the undetected external object 550.

The electronic device 100 according to an embodiment may provide safe autonomous driving by detecting the external object 20 that may not be detected using the first model 121 using the second model 122. By including the operation of inputting the cropped image 630 according to the difference between the first road region 510 and the second road region 520 to the second model 122 without adding a complex neural network model for detection of the external object 20, it is possible to identify the undetected external object 550 quickly and simply without excessive data throughput.

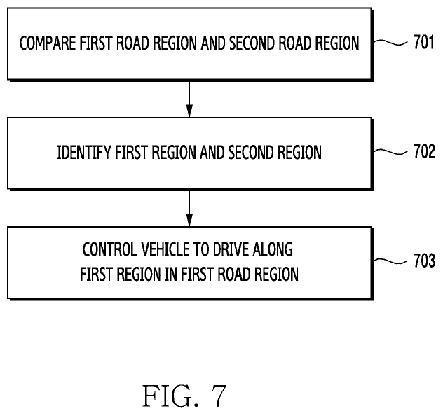

FIG. 7 is a flowchart illustrating an operation of controlling a vehicle by an electronic device according to an embodiment.

The operations shown in FIG. 7 may be operations of an electronic device (e.g., the electronic device 100 of FIG. 2) that are caused when instructions stored in the memory (e.g., the memory 120 of FIG. 2) are executed by the processor (e.g., the processor 110 of FIG. 1).

As described above, when there is an undetected external object (e.g., undetected external object 550 of FIG. 5A) by the first model (e.g., the first model 121 of FIG. 2), the electronic device 100 may classify the class of undetected external object 550 using the second model (e.g., the second model 122 of FIG. 2). However, when the time required to classify the class using the second model 122 is long, the electronic device 100 may prevent an accident by controlling the vehicle 10 to avoid the undetected external object 550.

Referring to FIG. 7, in operation 701, the electronic device 100 may compare the first road region (e.g., the first road region 510 of FIG. 6A) and the second road region (e.g., the second road region 520 of FIG. 5B).

For example, the instructions stored in the memory 120 may, when executed by the processor 110, cause the electronic device 100 to compare the first road region 510 and the second road region 520 and identify whether the first road region 510 and the second road region 520 match. Operation 701 may correspond to operation 405 of FIG. 4.

In operation 702, the electronic device 100 may identify the first region and the second region.

For example, the instructions stored in the memory 120 may, when executed by the processor 110, cause the electronic device 100 to identify a first region where the first road region 510 and the second road region 520 overlap and a second region distinct from the first region. The second region may be referred to as a region where the first road region 510 and the second road region 520 do not overlap.

For example, when there is an external object 550 undetected by the first model 121 in front, the first road region 510 may not include a region 502 including the pixels corresponding to the undetected external object 550. Since the second road region 520 is estimated based on the map data 223, even when the undetected external object 550 is present on the road 23, the second road region 520 may be estimated without considering the undetected external object 550. The second road region 520 may include a region 502 including the pixels corresponding to the undetected external object 550. As the first road region 510 and the second road region 520 are estimated by different methods, a difference between the first road region 510 and the second road region 520 may occur.

For example, the second region where the first road region 510 and the second road region 520 do not overlap may be referred to as a region 502 including the pixels corresponding to the undetected external object 550. The first region where the first road region 510 and the second road region 520 overlap may not include the region 502 including the pixels corresponding to the undetected external object 550.

In operation 703, the electronic device 100 may control the vehicle 10 to drive the vehicle 10 along the first region in the first road region 510.

For example, the instructions stored in the memory 120 may, when executed by the processor 110, cause the electronic device 100 to determine a driving route so that vehicle 10 drives along the first region in the first road region 510 and control the vehicle 10 based on the driving route. The first road region 510 estimated by the first model 121 may be estimated considering the external object 20 detected by the first model 121. Since the first region where the first road region 510 and the second road region 520 overlap does not include the region 502 including the pixels corresponding to the undetected external object 550, even when the vehicle 10 drives along the first region, a circumstance in which it is to contact the external object 20 may not occur.

If it is difficult to detect the undetected external object 550 using the second model 122 or when it takes a significant time to identify the undetected external object 550 using the second model 122, the undetected external object 550 and the vehicle 10 may contact each other before detecting the undetected external object 550. The electronic device 100 according to an embodiment may prevent an accident by controlling the driving of the vehicle 10 based on the first region in order to prevent contact between the undetected external object 550 and the vehicle 10. More specifically, the electronic device 100 may perform the above-described operations based on the time required to classify the class of the undetected external object 550 and the driving speed of the vehicle 10. Hereinafter, the operations of FIG. 7 are described in more detail.

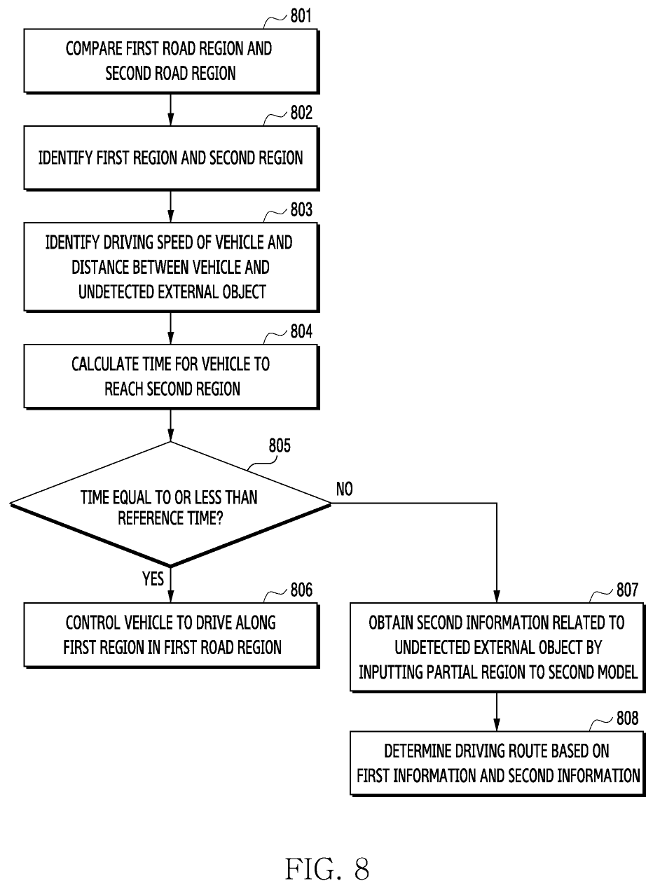

FIG. 8 is a flowchart illustrating an operation of controlling a vehicle before detecting an undetected external object by an electronic device according to an embodiment.

The operations shown in FIG. 8 may be operations of an electronic device (e.g., the electronic device 100 of FIG. 2) that are caused when instructions stored in the memory (e.g., the memory 120 of FIG. 2) are executed by the processor (e.g., the processor 110 of FIG. 1). Descriptions overlapping those of FIG. 7 may be skipped.

Referring to FIG. 8, in operation 801, the electronic device 100 may compare the first road region (e.g., the first road region 510 of FIG. 5A) and the second road region (e.g., the second road region 520 of FIG. 5B). Operation 801 may correspond to operation 701 of FIG. 7.

In operation 802, the electronic device 100 may identify the first region and the second region. Operation 802 may correspond to operation 702 of FIG. 7.

In operation 803, the electronic device 100 may identify the driving speed of the vehicle (e.g., the vehicle 10 of FIG. 1) and the distance between the vehicle 10 and the undetected external object (e.g., the undetected external object 550 of FIG. 5A).

For example, when the instructions stored in memory 120 are executed, the processor 110 may cause the electronic device 100 to identify the driving speed of the vehicle 10 and the distance between the vehicle 10 and the undetected external object 550.

For example, the driving speed of the vehicle 10 may be the current driving speed of the vehicle 10. Since the electronic device 100 controls autonomous driving of the vehicle 10, information indicating the current speed of the vehicle 10 may be identified. The current speed of the vehicle 10 may be identified based on the real-time speed of the vehicle 10.

For example, the electronic device 100 may identify the distance between the vehicle 10 and the undetected external object 550 using a sensor (e.g., the sensor 150 of FIG. 2). The sensor 150 may include, but is not limited to, a radar sensor 153 and/or a LiDAR sensor 152.

In operation 804, the electronic device 100 may calculate a time for the vehicle 10 to reach the second region.

For example, when the instructions stored in memory 120 are executed, the processor 110 may cause the electronic device 100 to calculate the time for the vehicle 10 to reach the second region based on the driving speed of the vehicle 10 and the distance between the vehicle 10 and the undetected external object 550. The time for the vehicle 10 to reach the second region may be calculated by dividing the distance by the speed.

As described above, the second region may be a region where the first road region 510 and the second road region 520 do not overlap. Since the region 502 including the pixels corresponding to the undetected external object 550 is included in the second region, the time when the vehicle 10 reaches the second region may be calculated by the timing when the vehicle 10 and the undetected external object 550 contact. For example, when the speed of the vehicle 10 is relatively fast, the timing when the vehicle 10 contacts the undetected external object 550 is decreased, so that the time for the vehicle 10 to reach the second region may be decreased. For example, when the speed of the vehicle 10 is relatively slow, the timing when the vehicle 10 and the undetected external object 550 contact each other is increased, so that the time when the vehicle 10 reaches the second region may be increased.

In operation 805, the electronic device 100 may compare the calculated time with a reference time and identify whether the time is less than or equal to the reference time.

For example, when the instructions stored in the memory 120 are executed, the processor 110 may cause the electronic device 100 to compare the calculated time with the reference time and identify whether the time is less than or equal to the reference time.

For example, when the timing of classifying the class of the undetected external object 550 by the second model 122 is before the timing when the vehicle 10 contacts the undetected external object 550, the electronic device 100 may determine the driving route of the vehicle 10 based on the class of the undetected external object 550. When the class of the undetected external object 550 is classified as a class requiring avoidance of the vehicle 10, the electronic device 100 may determine the driving route of the vehicle 10 to avoid the undetected external object 550. When the class of the undetected external object 550 is classified as a class that does not require avoidance of the vehicle 10, the electronic device 100 may determine a driving route passing through the undetected external object 550 of the vehicle 10. An accident may occur when the vehicle 10 contacts the undetected external object 550 before the electronic device 100 classifies the undetected external object 550.

According to an embodiment, the reference time may be determined based on a time taken to classify the undetected external object 550. The reference time may be longer than the time required to generate a cropped image 630 including the external object 20 in the image and input the cropped image 630 to the second model 122 and then classify the class of the external object 20 by the second model 122. For example, in order to set the reference time, the time required to detect the external object 20 using the second model 122 may be determined in advance. The average time required to extract various external objects from the image to generate cropped images, and input the cropped images to the second model 122 and classify the classes of the various external objects may be previously stored in the memory 120.

The reference time may be longer than the time required for the electronic device 100 to classify the undetected external object 550. Even when the timing at which the class of the undetected external object 550 is classified is before the timing when the vehicle 10 and the undetected external object 550 contact each other, when the interval between the timings is too short, it may be difficult for the vehicle 10 to avoid the undetected external object 550. To prevent an accident, the reference time may be longer than the time required to classify the undetected external object 550 considering the time required for the vehicle 10 to avoid the undetected external object 550. For example, when the time required for electronic device 100 to classify the undetected external object 550 is about 1 second to about 5 seconds, the reference time may be about 15 seconds, but is not limited thereto.

When the time is less than or equal to the reference time, operation 806 may be performed. When the time exceeds the reference time, operation 807 may be performed.

In operation 806, the electronic device 100 may control the vehicle 10 to drive the vehicle 10 along the first region in the first road region 510.

For example, when the instructions stored in the memory 120 are executed, the processor 110 may cause the electronic device 100 to control the vehicle 10 to drive along the first region based on identifying the time equal to or less than the reference time.

When the time for the vehicle 10 to reach the second region is less than or equal to the reference time, the vehicle 10 may contact the undetected external object 550. For example, when the time for the vehicle 10 to reach the second region is about 7 seconds, and the reference time is about 15 seconds, it may be difficult for the vehicle 10 to avoid the undetected external object 550. The processor 110 may determine a driving route as the first region based on identifying the time less than or equal to the reference time, and control the vehicle 10 to drive along the first region. The first region is a region where the first road region 510 and the second road region 520 overlap, and since it is a region where the undetected external object 550 is not present, the first region may be a region having a high probability of being a road 23. According to an embodiment, even before classifying the class of the undetected external object 550, the processor 110 may control the vehicle 10 to drive along the first region while avoiding the undetected external object 550 in order to prevent an accident.

In operation 807, the electronic device 100 may input the partial region to the second model 122 to obtain second information related to the undetected external object 550.

For example, when the instructions stored in the memory 120 are executed, the processor 110 may cause the electronic device 100 to extract a projection region to generate a cropped image 630 and input the cropped image 630 to the second model 122, classifying the class of the undetected external object 550. When the time exceeds the reference time, it may obtain second information by classifying the class of the undetected external object 550, determine a driving route based on the first information and the second information, and then secure a sufficient time for the vehicle 10 to drive based on the determined driving route. The processor 110 may obtain second information including information related to the class of the undetected external object 550.

In operation 808, the electronic device 100 may determine a driving route based on the first information and the second information.

For example, when the instructions stored in the memory 120 are executed, the processor 110 may cause the electronic device 100 to determine a driving route based on the first information and the second information. The first information may include information related to the class, position, and size of the detected external object 20, and information related to the position and size of the undetected external object 550. The second information may include information related to the class of the undetected external object 550. The processor 110 may determine a driving route for safe driving of the vehicle 10 comprehensively considering the first information and the second information, and control the vehicle 10 based on the determined driving route.

As described above, the electronic device 100 according to an embodiment may perform operations to prevent an accident that may occur when the timing of classifying the class of the undetected external object 550 is delayed. By the operations described in FIGS. 7 and 8, the electronic device 100 may prevent an accident due to contact with the undetected external object 550.

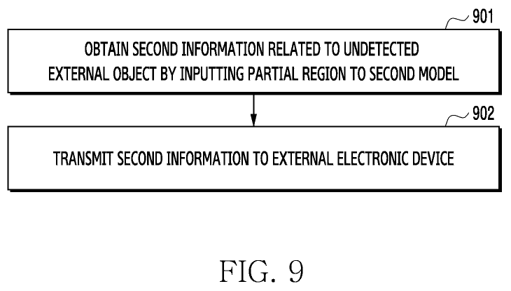

FIG. 9 is a flowchart illustrating an operation of transmitting second information to an external electronic device by an electronic device according to an embodiment.

For example, when the class of undetected external object 550 is classified, the electronic device 100 may transmit the second information to an external electronic device (e.g., the external electronic device 200 of FIG. 2) for another vehicle (e.g., another vehicle 21 of FIG. 1). The external electronic device 200 may identify the class of the undetected external object 550 through the second information received from the electronic device 100.

Referring to FIG. 9, in operation 901, the electronic device 100 may input the partial region to the second model 122 to obtain second information related to the undetected external object 550. Operation 901 may correspond to operation 807 of FIG. 8.

In operation 902, the electronic device 100 may transmit the second information to the external electronic device 200.

For example, the processor 110 may transmit the obtained second information to the external electronic device 200 based on obtaining the second information. For example, the external electronic device 200 may be referred to as a server, but is not limited thereto. For example, the external electronic device may include an electronic device for autonomous driving of another vehicle (e.g., another vehicle 21 of FIG. 1) and an electronic device disposed in a following vehicle that is distinct from the leading vehicle among platooning vehicles. By receiving the second information, the external electronic device 200 may obtain information about the undetected external object 550 and determine a driving route based on the second information. For example, when the external electronic device 200 is a server, the server may transmit the second information to the electronic device 100 disposed in the other vehicle 21. The electronic device 100 disposed in the other vehicle 21 may determine a driving route based on the second information. According to an embodiment, the second information may be shared through the external electronic device 200.

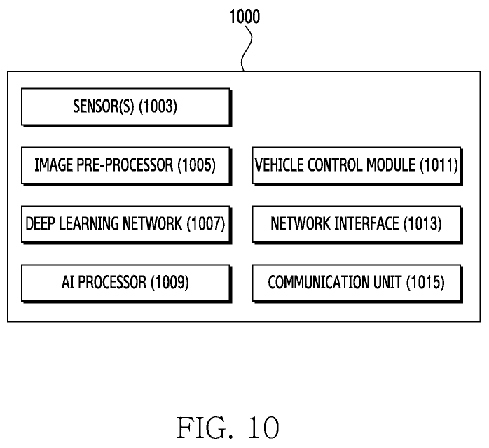

FIG. 10 is an example block diagram illustrating an autonomous driving system of a vehicle according to an embodiment.

The autonomous driving system 1000 of the vehicle according to FIG. 10 may be a deep learning network including sensors 1003, an image preprocessor 1005, a deep learning network 1007, an artificial intelligence (AI) processor 1009, a vehicle control module 1011, a network interface 1013, and a communication unit 1015. In various embodiments, each element may be connected via a variety of interfaces. For example, sensor data detected and output by the sensors 1003 may be fed to the image preprocessor 1005. The sensor data processed by the image preprocessor 1005 may be fed to the deep learning network 1007 run on the AI processor 1009. An output of the deep learning network 1007 run by the AI processor 1009 may be fed to the vehicle control module 1011. Intermediate results of the deep learning network 1007 run on the AI processor 1009 may be fed to the AI processor 1009. In various embodiments, the network interface 1013 communicates with an electronic device (e.g., the electronic device 100 of FIG. 2) in the vehicle to transmit autonomous driving route information and/or autonomous driving control commands for autonomous driving of the vehicle to its internal block components. In an embodiment, the network interface 1013 may be used to transmit sensor data obtained through the sensor(s) 1003 to an external server. In some embodiments, the autonomous driving control system 1000 may include additional or fewer components as appropriate. For example, in some embodiments, the image preprocessor 1005 may be an optional component. As another example, a post-processing element (not shown) may be included in the autonomous driving control system 1000 to perform post-processing of the output of the deep learning network 1007 before the output is provided to the vehicle control module 1011.

In some embodiments, the sensors 1003 may include one or more sensors. In various embodiments, the sensors 1003 may be attached to various different positions of the vehicle. The sensors 1003 may be arranged to face one or more different directions. For example, the sensors 1003 may be attached to the front, sides, rear, and/or roof of the vehicle to face directions such as forward-facing, rear-facing, side-facing and the like. In some embodiments, the sensors 1003 may be image sensors such as e.g., high dynamic range cameras. In some embodiments, the sensors 1003 may include non-visual sensors. In some embodiments, the sensors 1003 may include a radar, a light detection and ranging (LiDAR), and/or ultrasonic sensors in addition to the image sensor. In some embodiments, the sensors 1003 are not mounted on the vehicle having the vehicle control module 1011. For example, the sensors 1003 may be incorporated as a part of a deep learning system for capturing sensor data and may be installed onto an environment or a roadway and/or mounted on surrounding vehicles.

In some embodiments, the image preprocessor 1005 may be used to preprocess sensor data of the sensors 1003. For example, the image preprocessor 1005 may be used to preprocess sensor data to split sensor data into one or more components, and/or to post-process the one or more components. In some embodiments, the image preprocessor 1005 may be any one of a graphics processing unit (GPU), a central processing unit (CPU), an image signal processor, or a specialized image processor. In various embodiments, the image preprocessor 1005 may be a tone-mapper processor for processing high dynamic range data. In some embodiments, the image preprocessor 1005 may be a component of the AI processor 1009.

In some embodiments, the deep learning network 1007 may be a deep learning network for implementing control commands for controlling the autonomous vehicle. For example, the deep learning network 1007 may be an artificial neural network such as a convolution neural network (CNN) trained using sensor data, and the output of the deep learning network 1007 is provided to the vehicle control module 1011.

In some embodiments, the AI processor 1009 may be a hardware processor for running the deep learning network 1007. In some embodiments, the AI processor 1009 may be a specialized AI processor adapted to perform inference on sensor data through a CNN. In some embodiments, the AI processor 1009 may be optimized for a bit depth of the sensor data. In some embodiments, the AI processor 1009 may be optimized for deep learning operations such as operations in neural networks including convolution, inner product, vector, and/or matrix operations. In some embodiments, the AI processor 1009 may be implemented through a plurality of graphics processing units (GPUs) capable of effectively performing parallel processing.

In various embodiments, the AI processor 1009 may be coupled, through an input/output interface, to a memory configured to provide an AI processor having instructions causing the AI processor to perform deep learning analysis on the sensor data received from the sensor(s) 1003 while the AI processor 1009 is executed, and determine a result of machine learning used to operate a vehicle at least partially autonomously. In some embodiments, the vehicle control module 1011 may be used to process commands for vehicle control outputted from the AI processor 1009, and to translate the output of the AI processor 1009 into commands for controlling modules of each vehicle in order to control various modules in the vehicle. In some embodiments, the vehicle control module 1011 is used to control an autonomous driving vehicle. In some embodiments, the vehicle control module 1011 may adjust the steering and/or speed of the vehicle. For example, the vehicle control module 1011 may be used to control driving of a vehicle such as e.g., deceleration, acceleration, steering, lane change, keeping lane or the like. In some embodiments, the vehicle control module 1011 may generate control signals for controlling vehicle lighting, such as e.g., brake lights, turns signals, and headlights. In some embodiments, the vehicle control module 1011 may be used to control vehicle audio-related systems such as e.g., a vehicle's sound system, vehicle's audio warnings, a vehicle's microphone system, and a vehicle's horn system.

In some embodiments, the vehicle control module 1011 may be used to control notification systems including alert systems for notifying passengers and/or a driver of driving events, such as e.g., approaching an intended destination or a potential collision. In some embodiments, the vehicle control module 1011 may be used to adjust sensors such as the sensors 1003 of the vehicle. For example, the vehicle control module 1011 may control to modify the orientation of the sensors 1003, change the output resolution and/or format type of the sensors 1003, increase or decrease a capture rate, adjust a dynamic range, and adjust the focus of the camera. In addition, the vehicle control module 1011 may control to turn on/off the operation of the sensors individually or collectively.

In some embodiments, the vehicle control module 1011 may be used to change the parameters of the image preprocessor 1005 by means of modifying a frequency range of filters, adjusting features and/or edge detection parameters for object detection, adjusting bit depth and channels, or the like. In various embodiments, the vehicle control module 1011 may be used to control autonomous driving of the vehicle and/or driver assistance features of the vehicle.

In some embodiments, the network interface 1013 may serve as an internal interface between the block components of the autonomous driving control system 1000 and the communication unit 1015. Specifically, the network interface 1013 may be a communication interface for receiving and/or transmitting data including voice data. In various embodiments, the network interface 1013 may be connected to external servers via the communication unit 1015 to connect voice calls, receive and/or send text messages, transmit sensor data, update software of the vehicle to the autonomous driving system, or update software of the autonomous driving system of the vehicle.

In various embodiments, the communication unit 1015 may include various wireless interfaces of a cellular or WiFi type. For example, the network interface 1013 may be used to receive updates of the operation parameters and/or instructions for the sensors 1003, the image preprocessor 1005, the deep learning network 1007, the AI processor 1009, and the vehicle control module 1011 from an external server connected via the communication unit 1015. For example, a machine learning model of the deep learning network 1007 may be updated using the communication unit 1015. According to another embodiment, the communication unit 1015 may be used to update the operating parameters of the image preprocessor 1005, such as image processing parameters, and/or the firmware of the sensors 1003.

In another embodiment, the communication unit 1015 may be used to activate communication for emergency services and emergency contacts in an event of a traffic accident or a near-accident. For example, in a vehicle crash event, the communication unit 1015 may be used to call emergency services for help, and may be used to externally notify the crash details and the location of the vehicle to the designated emergency services. In various embodiments, the communication unit 1015 may update or obtain an expected arrival time and/or a location of destination.

According to an embodiment, the autonomous driving system 1000 illustrated in FIG. 10 may be configured as an electronic device 100 of a vehicle. According to an embodiment, when an autonomous driving release event occurs from the user while performing the autonomous driving of the vehicle, the AI processor 1009 of the autonomous driving system 1000 may make a control to input information related to the autonomous driving release event to the training set data of the deep learning network, thereby controlling to train the autonomous driving software of the vehicle.

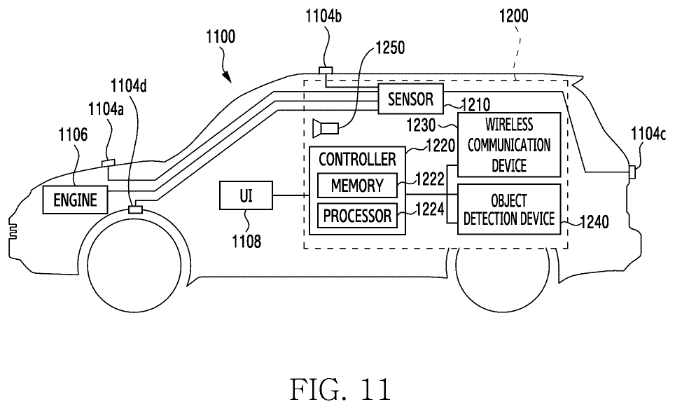

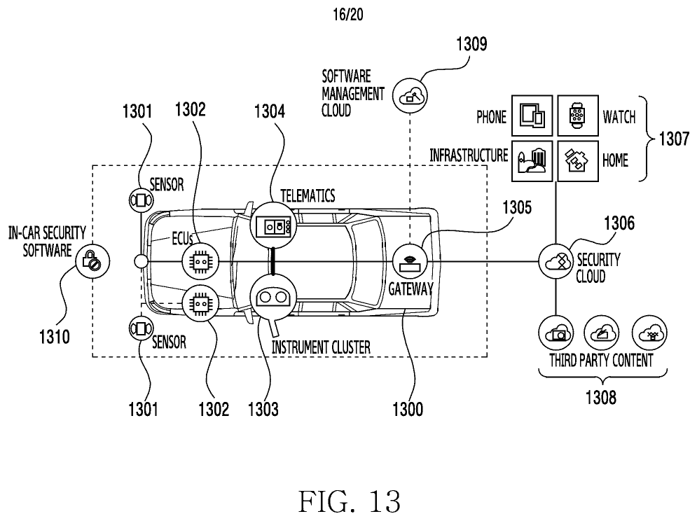

FIGS. 11 and 12 are example block diagrams illustrating an autonomous driving mobile body according to an embodiment. FIG. 13 illustrates an example of a gateway related to a user device according to various embodiments.

Referring to FIG. 11, the autonomous driving mobile body 1100 according to the present embodiment may include a control device 1200, sensing modules (1104a, 1104b, 1104c, 1104d), an engine 1106, and a user interface 1108.

The autonomous driving mobile body 1100 may have an autonomous driving mode or a manual mode. For example, according to a user input received through the user interface 1108, the manual mode may be switched to the autonomous driving mode, or the autonomous driving mode may be switched to the manual mode.

When the mobile body 1100 is operated in the autonomous driving mode, the autonomous driving mobile body 1100 may be operated under the control of the control device 1200.

In this embodiment, the control device 1200 may include a controller 1220 including a memory 1222 and a processor 1224, a sensor 1210, a communication device 1230, and an object detection device 1240.

Here, the object detection device 1240 may perform all or some of functions of the distance measuring device (e.g., the electronic device 101).

In other words, in the present embodiment, the object detection device 1240 is a device for detecting an object located outside the mobile body 1100, and the object detection device 1240 may be configured to detect an object located outside the mobile body 1100 and generate object information according to a result of the detection.

The object in formation may include information on the presence or absence of an object, location information of the object, distance information between the mobile body and the object, and relative speed information between the mobile body and the object.

The object may include various objects located outside the mobile body 1100, such as a traffic lane, another vehicle, a pedestrian, a traffic signal, light, a roadway, a structure, a speed bump, terrain, an animal, and the like. Here, the traffic signal may be of a concept including a traffic light, a traffic sign, a pattern or text drawn on a road surface. The light may be light generated from a lamp provided in another vehicle, light emitted from a streetlamp, or sunlight.

Further, the structure may indicate an object located around the roadway and fixed to the ground. For example, the structure may include, for example, a streetlamp, a street tree, a building, a telephone pole, a traffic light, a bridge, and the like. The terrain may include mountains, hills, and the like.

Such an object detection device 1240 may include a camera module. The controller 1220 may extract object information from an external image captured by the camera module and allow the controller 1220 to process the information.

Further, the object detection device 1240 may further include imaging devices for recognizing an external environment. A RADAR, a GPS device, a driving distance measuring device (odometer), other computer vision devices, ultrasonic sensors, and infrared sensors may be used in addition to a LIDAR, and these devices may be operated optionally or simultaneously as needed to enable more precise detection.

Meanwhile, the distance measuring device according to an embodiment of the disclosure may calculate the distance between the autonomous driving mobile body 1100 and the object, and control the operation of the mobile body based on the distance calculated in association with the control device 1200 of the autonomous driving mobile body 1100.

For example, when there is a possibility of collision depending upon the distance between the autonomous driving mobile body 1100 and the object, the autonomous driving mobile body 1100 may control the brake to slow down or stop. As another example, when the object is a moving object, the autonomous driving mobile body 1100 may control the driving speed of the autonomous driving mobile body 1100 to maintain a predetermined distance or more from the object.

The distance measuring device according to an embodiment of the disclosure may be configured as one module within the control device 1200 of the autonomous driving mobile body 1100. In other words, the memory 1222 and the processor 1224 of the control device 1200 may be configured to implement in software a collision avoidance method according to the present disclosure.

Further, the sensor 1210 may be connected to the sensing modules (1104a, 1104b, 1104c, 1104d) to obtain various sensing information about the environment inside and outside the mobile body. Here, the sensor 1210 may include, for example, a posture sensor (e.g., a yaw sensor, a roll sensor, a pitch sensor), a collision sensor, a wheel sensor, a speed sensor, an inclination sensor, a weight detection sensor, a heading sensor, a gyro sensor, a position module, a mobile body forward/backward sensor, a battery sensor, a fuel sensor, a tire sensor, a steering sensor for steering wheel rotation, a mobile body internal temperature sensor, a mobile body internal humidity sensor, an ultrasonic sensor, an illuminance sensor, an accelerator pedal position sensor, a brake pedal position sensor, and the like.

As such, the sensor 1210 may obtain various sensing signals, such as e.g., mobile body posture information, mobile body collision information, mobile body direction information, mobile body position information (GPS information), mobile body angle information, mobile body speed information, mobile body acceleration information, mobile body inclination information, mobile body forward/backward driving information, battery information, fuel information, tire information, mobile body lamp information, mobile body internal temperature information, mobile body internal humidity information, steering wheel rotation angle, mobile body external illuminance, pressure applied to an accelerator pedal, pressure applied to a brake pedal, and so on.

Further, the sensor 1210 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), and the like.

As such, the sensor 1210 may generate mobile body state information based on various detected data.

A wireless communication device 1230 may be configured to implement wireless communication between the autonomous driving mobile bodies 1100. For example, the autonomous driving mobile body 1100 can communicate with a mobile phone of the user or another wireless communication device 1230, another mobile body, a central apparatus (traffic control device), a server, or the like. The wireless communication device 1230 may transmit and receive wireless signals according to a wireless access protocol. The wireless communication protocol may be, for example, of Wi-Fi, Bluetooth, Long-Term Evolution (LTE), Code Division Multiple Access (CDMA), Wideband Code Division Multiple Access (WCDMA), and Global Systems for Mobile Communications (GSM), and the communication protocol is not limited thereto.

Further, according to the present embodiment, the autonomous driving mobile body 1100 may implement wireless communication between mobile bodies via the wireless communication device 1230. In other words, the wireless communication device 1230 may communicate with another mobile body and other mobile bodies over the road through vehicle-to-vehicle (V2V) communication. The autonomous driving mobile body 1100 may transmit and receive information, such as driving warnings and traffic information, via the vehicle-to-vehicle communication, and may request information or receive such a request from another vehicle. For example, the wireless communication device 1230 may perform the V2V communication with a dedicated short-range communication (DSRC) apparatus or a cellular-V2V (C-V2V) apparatus. In addition to vehicle-to-vehicle communication, vehicle-to-everything (V2X) communication between a vehicle and another object (e.g., an electronic device carried by a pedestrian) may also be implemented using the wireless communication device 1230.

Further, the wireless communication device 1230 may obtain, as information for autonomous driving of the autonomous driving mobile body 1100, information generated by various mobility devices including infrastructure (traffic lights, CCTVs, RSUs, eNode B, etc.), other autonomous driving/non-autonomous driving vehicles or the like that are located on a roadway over a non-terrestrial network other than a terrestrial network.

For example, the wireless communication device 1230 may perform wireless communication with a low earth orbit (LEO) satellite system, a medium earth orbit (MEO) satellite system, a geostationary orbit (GEO) satellite system, a high altitude platform (HAP) system, and so on, all these systems constituting a non-terrestrial network, via a dedicated non-terrestrial network antenna mounted on the autonomous driving mobile body 1100.

For example, the wireless communication device 1230 may perform wireless communication with various platforms that configure a Non-Terrestrial Network (NTN) according to the wireless access specification complying with the 5G NR NTN (5th Generation New Radio Non-Terrestrial Network) standard currently being discussed in 3GPP and others, but the disclosure is not limited thereto.

In this embodiment, the controller 1220 may control the wireless communication device 1230 to select a platform capable of appropriately performing the NTN communication in consideration of various information, such as the location of the autonomous driving mobile body 1100, the current time, available power, and the like and to perform wireless communication with the selected platform.

In this embodiment, the controller 1220, which is a unit for controlling the overall operation of each unit in the mobile body 1100, may be configured at the time of manufacture by a manufacturer of the mobile body or may be additionally adapted to perform an autonomous driving function after its manufacture. Alternatively, a configuration may be included for enabling the controller to continue ongoing additional functions through upgrades to the controller 1220 configured at the time of its manufacturing. Such a controller 1220 may be referred to as an electronic control unit (ECU).

The controller 1220 may be configured to collect various data from the sensor 1210 connected thereto, the object detection device 1240, the communication device 1230, and the like, and may transmit a control signal based on the collected data to the sensor 1210, the engine 1106, the user interface 1108, the wireless communication device 1230, and the object detection device 1240 that are included as other components in the mobile body. Further, although not shown herein, the control signal may be also transmitted to an accelerator, a braking system, a steering device, or a navigation device related to driving of the mobile body.

According to the present embodiment, the controller 1220 may control the engine 1106, and for example, the controller 1220 may control the engine 1106 to detect a speed limit of the roadway on which the autonomous driving mobile body 1100 is driving and to prevent its driving speed from exceeding the speed limit, or may control the engine 1106 to accelerate the driving speed of the autonomous driving mobile body 1100 within a range not exceeding the speed limit.

Further, in case where the autonomous driving mobile body 1100 is approaching the lane or departing from the lane during the driving of the autonomous driving mobile body 1100, the controller 1220 may determine whether such approaching the lane or departing from the lane is due to a normal driving condition or other driving conditions, and control the engine 1106 to control the driving of the vehicle based on the result of determination. More specifically, the autonomous driving mobile body 1100 may detect lanes formed on both sides of the lane in which the vehicle is driving. In such a case, the controller 1220 may determine whether the autonomous driving mobile body 1100 is approaching the lane or departing from the lane, and if it is determined that the autonomous driving mobile body 1100 is approaching the lane or departing from the lane, then the controller 1220 may determine whether such driving is in accordance with the correct driving condition or other driving conditions. Here, an example of the normal driving condition may be a situation where it is necessary to change the lane of the mobile body. Further, an example of other driving conditions may be a situation where it is not necessary to change the lane of the mobile body. When it is determined that the autonomous driving mobile body 1100 is approaching or leaving the lane in a situation where it is not necessary for the mobile body to change the lane, the controller 1220 may control the driving of the autonomous driving mobile body 1100 such that the autonomous driving mobile body 1100 does not leave the lane and continue to drive normally in that lane.

When another mobile body or any obstruction exists in front of the mobile body, the controller may control the engine 1106 or the braking system to decelerate the mobile body, and control the trajectory, the driving route, and the steering angle of the mobile body in addition to the driving speed. Alternatively, the controller 1220 may control the driving of the mobile body by generating necessary control signals based on information collected from the external environment, such as, e.g., the driving lane of the mobile body, the driving signals, and the like.

In addition to generating its own control signals, the controller 1220 may communicate with a neighboring mobile body or a central server and transmit commands for controlling peripheral devices through the information received therefrom, thereby controlling the driving of the mobile body.

Further, when the position of the camera module 1250 changes or the angle of view changes, it may be difficult to accurately recognize the mobile body or the lane in accordance with the present embodiment, and thus the controller 1220 may generate a control signal for controlling to perform calibration of the camera module 1250 in order to prevent such a phenomenon. Accordingly, in this embodiment, the controller 1220 may generate a calibration control signal to the camera module 1250 to continuously maintain the normal mounting position, orientation, angle of view, etc. of the camera module 1250, even if the mounting position of the camera module 1250 is changed due to vibrations or impacts generated according to the movement of the autonomous driving mobile body 1100. The controller 1220 may generate a control signal to perform calibration of the camera module 1250, in case where the pre-stored initial information of mounting position, orientation, and angle of view of the camera module 1250 varies by more than a threshold value from the initial mounting position, direction, and angle of view information of the camera module 1250 measured during the driving of the autonomous driving mobile body 1100.

In this embodiment, the controller 1220 may include a memory 1222 and a processor 1224. The processor 1224 may execute software stored in the memory 1222 according to a control signal of the controller 1220. More specifically, the controller 1220 may store in the memory 1222 data and instructions for performing the lane detection method in accordance with the present disclosure, and the instructions may be executed by the processor 1224 to implement the one or more methods disclosed herein.

In such a circumstance, the memory 1222 may be included in a non-volatile recording medium executable by the processor 1224. The memory 1222 may store software and data through an appropriate internal and external device. The memory 1222 may be comprised of a random access memory (RAM), a read only memory (ROM), a hard disk, and another memory 1222 connected to a dongle.

The memory 1222 may store at least an operating system (OS), a user application, and executable instructions. The memory 1222 may also store application data, array data structures and the like.

The processor 1224 may be a microprocessor or an appropriate electronic processor, such as a controller, a microcontroller, or a state machine.

The processor 1224 may be implemented as a combination of computing devices, and the computing device may include a digital signal processor, a microprocessor, or an appropriate combination thereof.

Meanwhile, the autonomous driving mobile body 1100 may further include a user interface 1108 for a user input to the control device 1200 described above. The user interface 1108 may allow the user to input information with appropriate interaction. For example, it may be implemented as a touch screen, a keypad, a control button, etc. The user interface 1108 may transmit an input or command to the controller 1220, and the controller 1220 may perform a control operation of the mobile body in response to the input or command.

Further, the user interface 1108 may allow a device outside the autonomous driving mobile body 1100 to communicate with the autonomous driving mobile body 1100 through the wireless communication device 1230. For example, the user interface 1108 may be in association with a mobile phone, a tablet, or other computing devices.

Furthermore, this embodiment describes that the autonomous driving mobile body 1100 includes the engine 1106, but it may be also possible to include another type of propulsion system. For example, the mobile body may be operated with electrical energy or may be operable by means of hydrogen energy or a hybrid system in combination thereof. Thus, the controller 1220 may include a propulsion mechanism according to the propulsion system of the autonomous driving mobile body 1100, and may provide control signals to components of each of the propulsion mechanism accordingly.

Hereinafter, a detailed configuration of the control device 1200 according to the present embodiment will be described in more detail with reference to FIG. 12.

The control device 1200 includes a processor 1224. The processor 1224 may be a general-purpose single-chip or multi-chip microprocessor, a dedicated microprocessor, a microcontroller, a programmable gate array, or the like. The processor may be referred to as a central processing unit (CPU). In this embodiment, the processor 1224 may be implemented with a combination of a plurality of processors.

The control device 1200 also includes a memory 1222. The memory 1222 may be any electronic component capable of storing electronic information. The memory 1222 may also include a combination of memories 1222 in addition to a single memory.

Data and instructions 1222a for performing a distance measuring method of the distance measuring device according to the present disclosure may be stored in the memory 1222. When the processor 1224 executes the instructions 1222a, all or some of the instructions 1222a and the data 1222b required for executing the instructions may be loaded onto the processor 1224 (e.g., 1224a or 1224b).

The control device 1200 may include a transmitter 1230a, a receiver 1230b, or a transceiver 1230c for allowing transmission and reception of signals. The one or more antennas (1232a, 1232b) may be electrically connected to the transmitter 1230a, the receiver 1230b, or each transceiver 1230c, or may further include antennas.

The control device 1200 may include a digital signal processor (DSP) 1270. The DSP 1270 may allow the mobile body to quickly process digital signals.

The control device 1200 may include a communication interface 1280. The communication interface 1280 may include one or more ports and/or communication modules for connecting other devices to the control device 1200. The communication interface 1280 may allow the user and the control device 1200 to interact with each other.

Various components of the control device 1200 may be connected together by one or more buses 1290, and the buses 1290 may include a power bus, a control signal bus, a state signal bus, a data bus, and the like. Under the control of the processor 1224, the components may transmit information to each other via the bus 1290 and perform a desired function.

On the other hand, in various embodiments, the control device 1200 may be associated with a gateway for communication with a secured cloud. For example, referring to FIG. 13, the control device 1200 may be related to a gateway 1305 for providing information obtained from at least one of components 1301 to 1304 of a vehicle 1300 to a security cloud 1306. For example, the gateway 1305 may be included in the control device 1200. As another example, the gateway 1305 may be configured as a separate device in the vehicle 1300 distinguished from the control device 1200. The gateway 1305 connects a software management cloud 1309 and a security cloud 1306, having different networks, with the network within the vehicle 1300 secured by in-car security software 1310, so that they can communicate with each other.

For example, a component 1301 may be a sensor. For example, the sensor may be used to obtain information about at least one of a state of the vehicle 1300 or a state around the vehicle 1300. For example, the component 1301 may include a sensor 1410.

For example, a component 1302 may be an electronic control unit (ECU). For example, the ECU may be used for engine control, transmission control, airbag control, and tire air-pressure management.

For example, a component 1303 may be an instrument cluster. For example, the instrument cluster may refer to a panel positioned in front of a driver's seat in a dashboard. For example, the instrument cluster may be configured to display information necessary for driving to the driver (or a passenger). For example, the instrument cluster may be used to display at least one of visual elements for indicating revolutions per minute (RPM) or rotations per minute of an engine, visual elements for indicating the speed of the vehicle 1300, visual elements for indicating a remaining fuel amount, visual elements for indicating a state of a transmission gear, or visual elements for indicating information obtained through the element 1301.

For example, a component 1304 may be a telematics device. For example, the telematics device may refer to an apparatus that combines wireless communication technology and global positioning system (GPS) technology to provide various mobile communication services, such as location information, safe driving or the like in the vehicle 1300. For example, the telematics device may be used to connect the vehicle 1300 with the driver, a cloud (e.g., the security cloud 1306), and/or a surrounding environment. For example, the telematics device may be configured to support a high bandwidth and a low latency, for a 5G NR standard technology (e.g., a V2X technology of 5G NR or a non-terrestrial network (NTN) technology of 5G NR). For example, the telematics device may be configured to support an autonomous driving of the vehicle 1300.

For example, the gateway 1305 may be used to connect the in-vehicle network within the vehicle 1300 with the software management cloud 1309 and the security cloud 1306, which are out-of-vehicle networks. For example, the software management cloud 1309 may be used to update or manage at least one software required for driving and managing of the vehicle 1300. For example, the software management cloud 1309 may be associated with the in-car security software 1310 installed in the vehicle. For example, the in-car security software 1310 may be used to provide a security function in the vehicle 1300. For example, the in-car security software 1310 may encrypt data transmitted and received via the in-vehicle network, using an encryption key obtained from an external authorized server for encryption of the in-vehicle network. In various embodiments, the encryption key used by the in-car security software 1310 may be generated based on the vehicle identification information (vehicle license plate, vehicle identification number (VIN)) or information uniquely assigned to each user (e.g., user identification information).

In various embodiments, the gateway 1305 may transmit data encrypted by the in-car security software 1310 based on the encryption key, to the software management cloud 1309 and/or the security cloud 1306. The software management cloud 1309 and/or the security cloud 1306 may use a decryption key capable of decrypting the data encrypted by the encryption key of the in-car security software 1310 to identify from which vehicle or user the data has been received. For example, since the decryption key is a unique key corresponding to the encryption key, the software management cloud 1309 and/or the security cloud 1306 may identify a sending entity (e.g., the vehicle or the user) of the data based on the data decrypted using the decryption key.

For example, the gateway 1305 may be configured to support the in-car security software 1310 and may be related to the control device 1200. For example, the gateway 1305 may be related to the control device 1200 to support a connection between the client device 1307 connected to the security cloud 1306 and the control device 1200. As another example, the gateway 1305 may be related to the control device 1200 to support a connection between a third party cloud 1308 connected to the security cloud 1306 and the control device 1200. However, the disclosure is not limited thereto.

In various embodiments, the gateway 1305 may be used to connect the vehicle 1300 to the software management cloud 1309 for managing the operating software of the vehicle 1300. For example, the software management cloud 1309 may monitor whether update of the operating software of the vehicle 1300 is required, and may provide data for updating the operating software of the vehicle 1300 through the gateway 1305, based on monitoring that the update of the operating software of the vehicle 1300 is required. As another example, the software management cloud 1309 may receive a user request to update the operating software of the vehicle 1300 from the vehicle 1300 via the gateway 1305 and provide data for updating the operating software of the vehicle 1300 based on the received user request. However, the disclosure is not limited thereto.

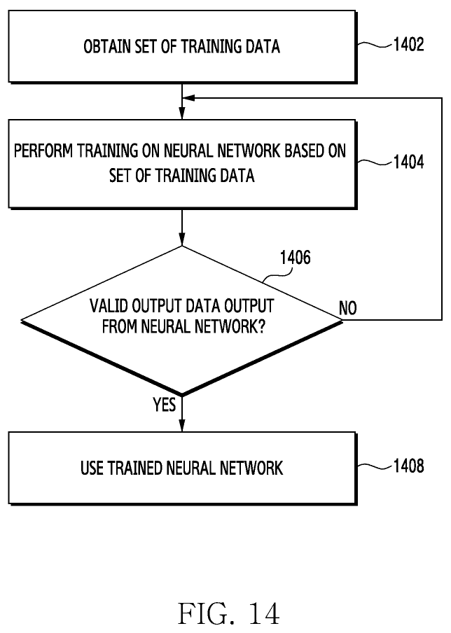

FIG. 14 is a view illustrating operations of an electronic device training a neural network based on a set of training data according to an embodiment.

The operations described with reference to FIG. 14 may be performed by the above-described electronic device (e.g., the electronic device 100 of FIG. 2).

Referring to FIG. 14, in operation 1402, the electronic device may obtain a set of training data according to an embodiment. The electronic device may obtain a set of training data for supervised learning. The training data may include a pair of input data and ground truth data corresponding to the input data. The ground truth data may indicate output data to be obtained from a neural network that has received input data, which forms the pair with the ground truth data. The ground truth data may be obtained by the above-described electronic device.

For example, when training the neural network for image recognition, the training data may include images and information about one or more subjects included in the images. The information may include the category or class of subjects identifiable through the image. The information may include the position, width, height, and/or size of the visual object corresponding to the subject in the image. The set of training data identified through operation 1402 may include pairs of a plurality of training data. In the example of training the neural network for image recognition, the set of training data identified by the electronic device may include a plurality of images and ground truth data corresponding to each of the plurality of images.

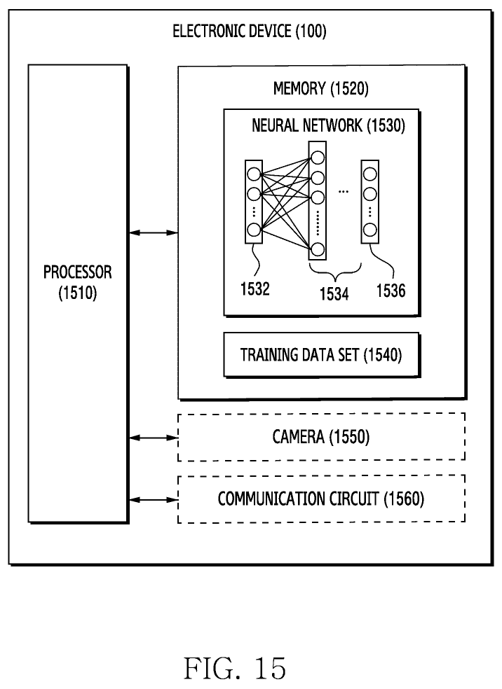

Referring to FIG. 14, in operation 1404, the electronic device according to an embodiment may perform training on the neural network based on the set of training data. In an embodiment in which the neural network is trained based on supervised learning, the electronic device may input input data included in the training data to the input layer of the neural network. An example of the neural network including the input layer is described with reference to FIG. 15. From the output layer of the neural network receiving the input data through the input layer, the electronic device may obtain output data of the neural network corresponding to the input data.

In an embodiment, the training of operation 1404 may be performed based on a difference between the output data and the ground truth data included in the training data and corresponding to the input data. For example, the electronic device may adjust one or more parameters (e.g., weights described below with reference to FIG. 15) related to the neural network to reduce the difference based on a gradient descent algorithm. The operation of the electronic device adjusting the one or more parameters may be referred to as tuning of the neural network. The electronic device may perform tuning of the neural network based on output data using a function defined to evaluate the performance of the neural network, such as a cost function. The difference between the above-described output data and the ground truth data may be included as an example of the cost function.

Referring to FIG. 14, in operation 1406, according to an embodiment, the electronic device may identify whether valid output data is output from the neural network trained in operation 1404. That the output data is valid may mean that the difference (or cost function) between the output data and the ground truth data meets a condition set for use of the neural network. For example, when the average and/or maximum value of the difference between the output data and the ground truth data is less than or equal to a designated threshold, the electronic device may determine that valid output data is output from the neural network.

When valid output data is not output from the neural network (No in 1406), the electronic device may repeatedly perform training of the neural network based on operation 1404. The embodiments are not limited thereto, and the electronic device may repeatedly perform operations 1402 and 1604.

In a state in which valid output data is obtained from the neural network (Yes in 1406), based on operation 1408, the electronic device according to an embodiment may use the trained neural network. For example, the electronic device may input other input data distinct from the input data input to the neural network as training data, to the neural network. The electronic device may use the output data obtained from the neural network receiving the other input data as a result of performing inference on the other input data based on the neural network.

FIG. 15 is a block diagram of an electronic device according to an embodiment.

The electronic device 100 of FIG. 15 may include the above-described electronic device.

For example, the operations described with reference to FIG. 14 may be performed by the electronic device 100 of FIG. 15 and/or the processor 1510 of FIG. 15.

Referring to FIG. 15, a processor 1510 of the electronic device 100 may perform computations related to a neural network 1530 stored in a memory 1520. The processor 1510 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 15, the processor 1510 may identify the neural network 1530 stored in the memory 1520. The neural network 1530 may include a combination of an input layer 1532, one or more hidden layers 1534 (or intermediate layers), and an output layer 1536. The above-described layers (e.g., the input layer 1532, the one or more hidden layers 1534, and the output layer 1536) may include a plurality of nodes. The number of hidden layers 1534 may vary depending on embodiments, and the neural network 1530 including a plurality of hidden layers 1534 may be referred to as a deep neural network. Operation of training the deep neural network may be referred to as deep learning.

In an embodiment, when the neural network 1530 has a structure of a feed forward neural network, a first node included in a particular layer may be connected to all of second nodes included in another prior to that particular layer. In the memory 1520, the parameters stored for the neural network 1530 may include weights assigned to connections between the second nodes and the first node. In the neural network 1530 having such a structure of feedforward neural network, a value of the first node may correspond to a weighted sum of values assigned to the second nodes, based on weights assigned to connections connecting the second nodes and the first node.

In an embodiment, when the neural network 1530 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 1520, the parameters stored for the neural network 1530 may include weights indicating the filter. The filter may include, among the second nodes, one or more nodes to be used to calculate a weighted sum of the first nodes, and weights corresponding to the one or more nodes, respectively.

According to an embodiment, the processor 1510 of the electronic device 100 may perform training on the neural network 1530, using the training data set 1540 stored in the memory 1520. Based on the training data set 1540, the processor 1510 may adjust one or more parameters stored in the memory 1520 for the neural network 1530.

According to an embodiment, the processor 1510 of the electronic device 100 may perform object detection, object recognition, and/or object classification, using the neural network 1530 trained based on the training data set 1540. The processor 1510 may input an image (or video) obtained through the camera 1550 to the input layer 1532 of the neural network 1530. Based on the input layer 1532 to which the image is input, the processor 1510 may sequentially obtain values of nodes of layers included in the neural network 1530 to obtain a set (e.g., output data) of values of nodes of the output layer 1536. The output data may be used based on a result of inferring information included in the image using the neural network 1530. Embodiments of the disclosure are not limited thereto, and the processor 1510 may input, to the neural network 1530, an image (or video) obtained from an external electronic device connected to the electronic device 101 through the communication circuit 1560.

In an embodiment, the neural network 1530 trained to process an image may be used to identify an area corresponding to a subject in the image (e.g., object detection) and/or identify a class of the subject represented in the image (e.g., object recognition and/or object classification). For example, the electronic device 101 may segment an area corresponding to the subject in the image, based on a rectangular shape such as e.g., a bounding box, using the neural network 1530. For example, the electronic device 101 may identify at least one class that matches the subject from among a plurality of specified classes, using the neural network 1530.

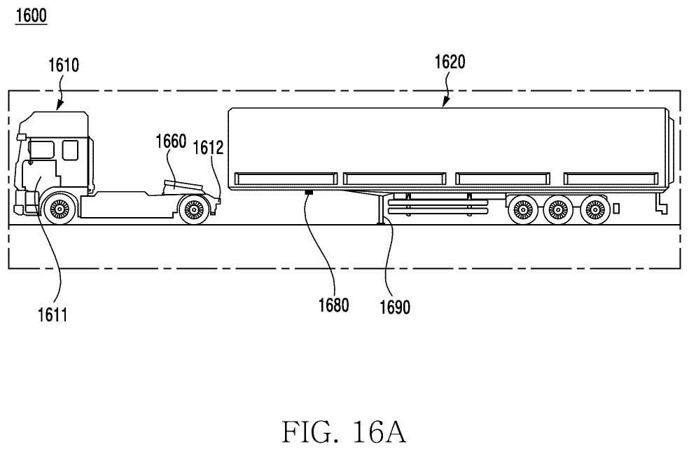

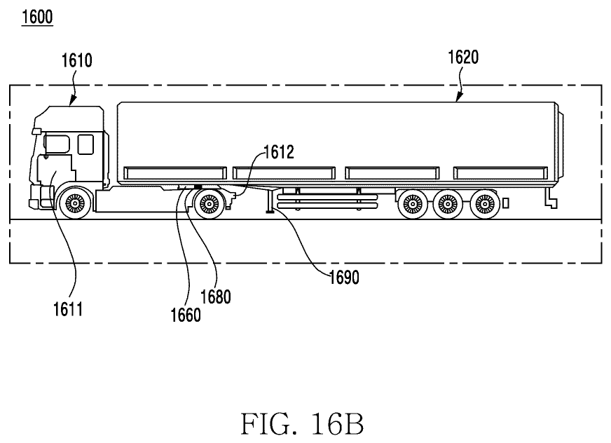

FIGS. 16A and 16B illustrate an example of an autonomous vehicle.

The above-described platooning vehicle may be referred to as a conventional truck.

Throughout the years, the trucking industry experienced steady growth and expanded the reach of its services to respond to more complex supply chains. These services include last-mile deliveries, drop-trailer programs, and intermodal transportation at ports (in which freight is carried to the destination by two or more different means of transportation (ship and rail, ship and airplane).

As such, because the methods of transporting freight are very diverse, manufacturers of freight-related equipment have designed different types of equipment to transport freight according to various transportation needs.

In the disclosure, a truck that tows a trailer for the main purpose of freight carrying or catering is collectively referred to as a tractor.

Tractors described in the disclosure may be classified into conventional trucks (or bonneted trucks), cab-over trucks (or cab-over engines), and semi-conventional trucks, which are intermediate forms of conventional trucks and cab-over trucks, depending on the location and shape of the tractor's cab.

The conventional truck has a structure in which the engine and the hood are positioned on the front axle of the tractor's cap, allowing the driver to sit behind the front axle, and is a type of tractor mainly used in North America where the tractor's engine is positioned in front of the driver.

On the other hand, the cap-over truck has a structure in which the cap of the tractor is positioned to the front end of the tractor, allowing the driver to sit in front of the front axle, and the front of the tractor is in the form of a so-called “flat face (or flat nose)” where the tractor's engine is positioned below the driver, which is a type of tractor mainly used in most countries such as Europe and Asia.

Just as there are various forms depending on the purpose and demand of a tractor, there are various forms of trailers towed by tractors. Among them, the most representative types of trailers are full-trailers and semi-trailers. The full-trailer and the semi-trailer may be distinguished by whether the trailer is equipped with both front and rear axles. Such a trailer may be connected to a box truck or a tractor through a coupling device.

Specifically, the full-trailer is a commercial freight trailer equipped with both front and rear axles. The full-trailer is designed to support the total load only with the trailer, so that it may fully support its weight without relying on a tractor, and is equipped with a drawbar to be coupled with a hauling unit (or towing unit) such as a tractor, and is mainly in the United States and Canada.

On the other hand, the semi-trailer is a freight trailer equipped with only a rear axle without a front axle, and supports a large portion of the load by a tractor connected by a type of hitch called a “fifth wheel.” When the semi-trailer is detected from the tractor and becomes stationary, the load of the trailer may be supported by spreading the landing gear mounted on the lower portion of the semi-trailer perpendicularly to the ground. A combination of a semi-trailer and a tractor is referred to as a “semi-trailer truck” (in the U.S., simply referred to as a “semi-trailer,”, a “tractor-trailer,” a “semi-truck,” a “big rig,” or a “semi”). The above-described “fifth wheel” refers to a horizontal wheel attached to the tractor axle of the trailer truck to facilitate the direction change of the trailer. The “fifth wheel” is a device that allows the tractor and the semi-trailer to be operably coupled to each other and typically includes a lower portion constituted of a hitch device and a trunnion plate for securing the kingpin mounted on the semi-trailer to the tractor.

Hereinafter, in the disclosure, based on the terms of the tractors/trailers described above, “trailer” is used as referring to a freight transportation vehicle connected to a tractor for a trailer, and “trailer” is used as referring to a towing vehicle for moving the trailer for convenience of description. Further, in the disclosure, in order to exclude the limitation of rights according to the embodiments described in the detailed description as much as possible, a tractor that hauls/tows a “trailer” may be described interchangeably with “towing vehicle” and a trailer towed by a tractor may be described interchangeably with “towed vehicle.”

Further, for convenience of description, it is preferable to understand that the “trailer” described throughout the specification refers to a “semi-trailer,” but is not limited thereto.

The trailer 1620 shown in FIGS. 16A and 16B of the disclosure is illustrated as a “semi-trailer”, but this is for convenience of description, and it should not be understood that the embodiments of the disclosure are applied only to a “semi-trailer” form.

Referring to FIGS. 16A and 16B, a vehicle 1600 including a tractor or tractor unit 1610 and a semi-trailer 1620 is exemplarily illustrated. FIG. 16A illustrates a state in which the tractor 1610 and the semi-trailer 1620 are not connected, and FIG. 16B illustrates a state in which the tractor 1610 and the semi-trailer 1620 are connected. In an embodiment, the semi-trailer 1620 may be selectively connected by a fifth wheel hitch 1660 carried by the tractor 1610, and the fifth wheel hitch 1660 may engage to the kingpin 1680 fixed to the semi-trailer 1620 in a known manner. The vehicle 1600 including the tractor 1610 and the semi-trailer 1620 may be referred to as a truck. The vehicle 1600 may include only the tractor 1610. The semi-trailer 1620 shown in FIGS. 16A and 16B is illustrated as a “semi-trailer” form, but this is for convenience of description, and it should not be understood that the embodiments of the disclosure are applied only to a “semi-trailer” form. The tractor 1610 shown in FIGS. 16A and 16B is illustrated as a “cab-over truck” form, but this is for convenience of description, and it should not be understood that the embodiments of the disclosure are applied only to a “cab-over truck” form.

In an embodiment, the tractor 1610 may include a front part 1611 and a rear part 1612. The front part 1611 may include a cab or cabin in which the driver sits. The rear part 1612 may be equipped with a fifth wheel hitch 1660 to which the semi-trailer 1620 is coupled. In an embodiment, the semi-trailer 1620 may include a king pin 1680 coupled to the fifth wheel hitch 1660 of the tractor 1610 and a landing gear 1690 that supports the semi-trailer 1620 against the ground when the semi-trailer 1620 is not coupled to the tractor 1610. The king pin 1680 and the landing gear 1690 may be installed on the lower portion of the semi-trailer 1620.

In an embodiment, the tractor 1610 may include an internal combustion engine, referred to as an engine, a motor, or a combination thereof. The tractor 1610 may include a battery and/or a fuel tank (e.g., a fuel tank designed to store gasoline, diesel, liquid natural gas (LNG), liquefied petroleum gas (LPG) and/or hydrogen). For example, the tractor 1610 including a rechargeable battery and a motor driven by electrical energy stored in the battery may be referred to as an electric vehicle (EV) and/or an electric truck. For example, the tractor 1610 including not only a battery and a motor but also a fuel tank and an engine may be referred to as a hybrid vehicle (e.g., plug-in hybrid electric vehicle (PHEV)).

In an embodiment, the semi-trailer 1620 may be coupled to or detached from the tractor 1610. For example, the semi-trailer 1620 may be connected to the rear part 1612 of the tractor 1610. The semi-trailer 1620 coupled to the tractor 1610 may be towed by the tractor 1610. To support driving on curved roads, the semi-trailer 1620 may be rotatably coupled to the tractor 1610. For example, the tractor 1610 and the semi-trailer 1620 may be rotatably coupled through a coupling device including the fifth wheel hitch 1660 and the king pin 1680. However, the link mechanism between the tractor 1610 and the semi-trailer 1620 is not limited thereto.

An electronic device for autonomous driving of a vehicle is provided. The electronic device may comprise a processor, a memory storing instructions, and a camera. The instructions may, when executed by the processor, cause the electronic device to obtain an image related to a front side of the vehicle via the camera, based on detecting an external object included in the image, obtain first information related to the external object using a first model, based on the first information, estimate a first road region related to a road in the image, based on map data, estimate a second road region in the image, compare the first road region and the second road region to extract a partial region related to an undetected external object by the first model, and input the partial region to a second model to obtain second information related to the undetected external object in the partial region from the second model.

According to an embodiment, the first model may include an object detection model trained to output a class related to the external object, a location related to the external object, and a size related to the external object, in the image.

According to an embodiment, the second model may include an object classification model trained to output a class related to the external object in the image.

According to an embodiment, the instructions may, when executed by the processor, cause the electronic device to determine a driving route of the vehicle, based on the first information and the second information.

According to an embodiment, the instructions may, when executed by the processor, cause the electronic device to identify a first region where the first road region and the second road region overlap each other and a second region distinct from the first region, based on a comparison between the first road region and the second road region, and control the vehicle to drive the vehicle along the first region in the first road region.

According to an embodiment, the instructions may, when executed by the processor, cause the electronic device to identify a driving speed of the vehicle, and a distance between the vehicle and the undetected external object, and based on the driving speed and the distance, control the vehicle to drive the vehicle along the first region.

According to an embodiment, the instructions may, when executed by the processor, cause the electronic device to, based on the driving speed and the distance, calculate a time when the vehicle reaches the second region, and based on identifying the time equal to or less than a reference time, control the vehicle to drive the vehicle along the first region.

According to an embodiment, the reference time may be determined based on a time taken to classify the undetected external object.

According to an embodiment, the electronic device may further comprise a wireless communication device. According to an embodiment, the instructions may, when executed by the processor, cause the electronic device to transmit the second information to an external electronic device, via the wireless communication device. According to an embodiment, the external electronic device may include at least one of a server or an electronic device disposed in another vehicle.

A method of an electronic for autonomous driving of a vehicle is provided. The method may comprise obtaining an image related to a front side of the vehicle, based on detecting an external object included in the image, obtaining first information related to the external object using a first model, based on the first information, estimating a first road region related to a road in the image, based on map data, estimating a second road region in the image, comparing the first road region and the second road region to extract a partial region related to an undetected external object by the first model, and inputting the partial region to a second model to obtain second information related to the undetected external object in the partial region from the second model.

According to an embodiment, the first model may include an object detection model trained to output a class related to the external object, a location related to the external object, and a size related to the external object, in the image.

According to an embodiment, the second model may include an object classification model trained to output a class related to the external object in the image.

According to an embodiment, the method may further comprise determining a driving route of the vehicle, based on the first information and the second information.

According to an embodiment, the method may further comprise identifying a first region where the first road region and the second road region overlap each other and a second region distinct from the first region, based on a comparison between the first road region and the second road region, and controlling the vehicle to drive the vehicle along the first region in the first road region.

According to an embodiment, the method may further comprise, based on the driving speed and the distance, controlling the vehicle to drive the vehicle along the first region.

According to an embodiment, the method may further comprise, based on the driving speed and the distance, calculating a time when the vehicle reaches the second region, and based on identifying the time equal to or less than a reference time, controlling the vehicle to drive the vehicle along the first region.

According to an embodiment, the reference time may be determined based on a time taken to classify the undetected external object.

According to an embodiment, the method may further comprise transmitting the second information to an external electronic device, via a wireless communication device.

According to an embodiment, the external electronic device may include at least one of a server or an electronic device disposed in another vehicle.

What is claimed is:

1. An electronic device for autonomous driving of a vehicle, comprising:
a processor;
a memory storing instructions; and
a camera,
wherein the instructions, when executed by the processor, cause the electronic device to:
obtain an image related to a front side of the vehicle via the camera,
based on detecting an external object included in the image, obtain first information related to the external object using a first model,
based on the first information, estimate a first road region related to a road in the image,
based on map data, estimate a second road region in the image,
compare the first road region and the second road region to extract a partial region related to an undetected external object by the first model, and
input the partial region to a second model to obtain second information related to the undetected external object in the partial region from the second model.

2. The electronic device of claim 1,
wherein the first model includes an object detection model trained to output a class related to the external object, a location related to the external object, and a size related to the external object, in the image.

3. The electronic device of claim 1,
wherein the second model includes an object classification model trained to output a class related to the external object in the image.

4. The electronic device of claim 1,
wherein the instructions, when executed by the processor, cause the electronic device to:
determine a driving route of the vehicle, based on the first information and the second information.

5. The electronic device of claim 1,
wherein the instructions, when executed by the processor, cause the electronic device to:
identify a first region where the first road region and the second road region overlap each other and a second region distinct from the first region, based on a comparison between the first road region and the second road region, and
control the vehicle to drive the vehicle along the first region in the first road region.

6. The electronic device of claim 5,
wherein the instructions, when executed by the processor, cause the electronic device to:
identify a driving speed of the vehicle, and a distance between the vehicle and the undetected external object, and
based on the driving speed and the distance, control the vehicle to drive the vehicle along the first region.

7. The electronic device of claim 6,
wherein the instructions, when executed by the processor, cause the electronic device to:
based on the driving speed and the distance, calculate a time when the vehicle reaches the second region, and
based on identifying the time equal to or less than a reference time, control the vehicle to drive the vehicle along the first region.

8. The electronic device of claim 7,
wherein the reference time is determined based on a time taken to classify the undetected external object.

9. The electronic device of claim 1, further comprising a wireless communication device,
wherein the instructions, when executed by the processor, cause the electronic device to:
transmit the second information to an external electronic device, via the wireless communication device.

10. The electronic device of claim 9,
wherein the external electronic device includes at least one of a server or an electronic device disposed in another vehicle.

11. A method of an electronic for autonomous driving of a vehicle, the method comprising:
obtaining an image related to a front side of the vehicle;
based on detecting an external object included in the image, obtaining first information related to the external object using a first model;
based on the first information, estimating a first road region related to a road in the image;
based on map data, estimating a second road region in the image;
comparing the first road region and the second road region to extract a partial region related to an undetected external object by the first model; and
inputting the partial region to a second model to obtain second information related to the undetected external object in the partial region from the second model.

12. The method of claim 11,
wherein the first model includes an object detection model trained to output a class related to the external object, a location related to the external object, and a size related to the external object, in the image.

13. The method of claim 11,
wherein the second model includes an object classification model trained to output a class related to the external object in the image.

14. The method of claim 11, further comprising
determining a driving route of the vehicle, based on the first information and the second information.

15. The method of claim 11, further comprising:
identifying a first region where the first road region and the second road region overlap each other and a second region distinct from the first region, based on a comparison between the first road region and the second road region; and
controlling the vehicle to drive the vehicle along the first region in the first road region.

16. The method of claim 15, further comprising:
based on a driving speed of the vehicle and a distance between the vehicle and the undetected external object, controlling the vehicle to drive the vehicle along the first region.

17. The method of claim 16, further comprising:
based on the driving speed and the distance, calculating a time when the vehicle reaches the second region; and
based on identifying the time equal to or less than a reference time, controlling the vehicle to drive the vehicle along the first region.

18. The method of claim 17,
wherein the reference time is determined based on a time taken to classify the undetected external object.

19. The method of claim 11, further comprising:
transmitting the second information to an external electronic device, via a wireless communication device.

20. The method of claim 19,
wherein the external electronic device includes at least one of a server or an electronic device disposed in another vehicle.
